(19) United States
(12) Patent Application Publication
(10) Pub. No.: US 2024/0297329 A1
(43) Pub. Date: Sep. 5, 2024

(54) FUEL CELL DEVICE

(71) Applicant: EKPO Fuel Cell Technologies GmbH, Dettingen (DE)

(72) Inventors: Fabian MÖNCH, Neckartailfingen (DE); Gerhard SCHULLER, Reutlingen (DE); Wolfgang FRITZ, Metzingen (DE); Kai WAHL, Metzingen (DE); Alexander GRÖH, Stuttgart (DE); Eric HENDEL, Frickenhausen (DE); Michael KAZMAIER, Reutlingen (DE); Paul VOLZ, Reutlingen (DE); Jürgen KRAFT, Metzingen (DE); Oliver FINK, Metzingen (DE)

(73) Assignee: EKPO Fuel Cell Technologies GmbH, Dettingen (DE)

(21) Appl. No.: 18/661,263

(22) Filed: May 10, 2024

Related U.S. Application Data
(63) Continuation of application No. PCT/EP2022/082352, filed on Nov. 17, 2022.

(30) Foreign Application Priority Data
Nov. 18, 2021 (DE) 10 2021 213 008.9

(51) Int. Cl. H01M 8/248; H01M 8/2475

(52) U.S. Cl. CPC H01M 8/248; H01M 8/2475

(57) ABSTRACT

The invention relates to a fuel cell device (300), in particular for a means of transport, wherein the fuel cell device (300) comprises the following: a fuel cell stack (100), and a stack longitudinal axis stabilizer (116), wherein at least one region of the stack longitudinal axis stabilizer (116) is arranged between a stack surface of the fuel cell stack (100) extending in parallel with the stack longitudinal axis and an abutment (118).

### RELATED APPLICATION

This application is a continuation of international application No. PCT/EP2022/082352 filed on Nov. 17, 2022, and claims the benefit of German application No. 10 2021 213 008.9 filed on Nov. 18, 2021, which are incorporated herein by reference in their entirety and for all purposes.

### FIELD OF DISCLOSURE

The present invention relates to the field of fuel cell technology—in particular, the field of fuel cell technology for locomotion means and the stabilization of fuel cell stacks.

### BACKGROUND

Fuel cells offer a possibility for decarbonization and are increasingly being installed more frequently, including in locomotion means, such as motor vehicles. With regard to the operational safety, stability, the complexity of the structure, and manufacturing costs, there is further need for improvement.

With this in mind, the object is to provide a fuel cell and components for fuel cells which continuously allow safe fuel cell operation and allow a simple structure and cost-effective production.

### SUMMARY OF THE INVENTION

According to the invention, the object is achieved by a fuel cell device—in particular, for a locomotion means—wherein the fuel cell device comprises the following: a fuel cell stack and a stack longitudinal axis stabilizer, wherein at least one region of the stack longitudinal axis stabilizer is arranged between a stack surface of the fuel cell stack, said surface running parallel to the stack longitudinal axis, and an abutment.

The locomotion means can, for example, be a motor vehicle—in particular, a motor vehicle which is driven at least partially with the aid of the fuel cell device. The motor vehicle can be suitable for trips on paved and/or unpaved roads. It can, for example, be a passenger car or truck.

Parallel here means that the parallel elements (for example, the stack longitudinal axis and the stack surface) run at an angle of at most 20°, e.g., at most 10°, to each other.

The abutment is preferably arranged on a further component of the fuel cell device—for example, on a component of the fuel cell device which is spaced apart from the stack surface of the fuel cell stack. In particular, the abutment described here in connection with the stack longitudinal axis stabilizer can be a further component of the fuel cell device—for example, a component of the fuel cell device which is spaced apart from the stack surface of the fuel cell stack.

The abutment can be arranged, for example, on a stack enclosure. In particular, the abutment described here in connection with the stack longitudinal axis stabilizer can be the stack enclosure itself or a part of the stack enclosure. The stack enclosure includes here all parts of the fuel cell device which extend into a region spaced apart from the stack surface—in particular, parts which at least partially surround the fuel cell stack. The region spaced apart from the stack surface lies outside the fuel cell stack and extends into a plane that intersects the fuel cell stack and runs orthogonally to the longitudinal axis of the fuel cell stack.

In the fuel cell device according to the invention, successive reaction zones along the stack longitudinal axis are typically each sealed by seals. The seals are used, inter alia, to ensure that a supplied fuel, e.g., hydrogen (H₂), does not escape from the fuel cell stack in an uncontrolled manner.

The rigidity of the fuel cell stack along the stack longitudinal axis is limited by the seals, and bends or bulges along the stack longitudinal axis can occur, as explained below in particular with reference to FIGS. 1 and 2. The stack longitudinal axis extends through the fuel cell stack orthogonally to the bipolar plate planes.

The invention stabilizes the stack longitudinal axis in a particularly simple manner. Impairments of the fuel cell operation, which could occur, for example, due to leakage of the fuel cell stack as a result of a bulge, can largely be avoided. This allows safe fuel cell operation continuously, even in the event of impacts and vibrations. At the same time, a simple structure and cost-effective production are ensured.

Typically, the stack longitudinal axis stabilizer can transmit at least a part of a force acting upon the fuel cell stack orthogonally to the stack longitudinal axis to the abutment. This can be sufficient for desired stabilization along the stack longitudinal axis.

The fuel cell device can comprise a plurality of stack longitudinal axis stabilizers. The fuel cell device can comprise any number of stack longitudinal axis stabilizers, e.g., at least one, in particular at least two, preferably at least three, and particularly preferably at least four stack longitudinal axis stabilizers.

Preferably, at least one region of each stack longitudinal axis stabilizer is arranged between one of the stack surfaces of the fuel cell stack, said surface running parallel to the stack longitudinal axis, and one or more abutments.

Preferably, one or more stack longitudinal axis stabilizers can each transmit at least a part of a plurality of forces, acting upon the fuel cell stack in different directions orthogonally to the stack longitudinal axis, to one or more abutments.

Preferably, at least a part of at least one stack longitudinal axis stabilizer is arranged in a contact region of a stack surface in which no fluid-conducting structures (for example, lines, hoses, and/or distributors) run. It can be particularly advantageous if at least a part of the stack longitudinal axis stabilizer is elastic. At least a part of the stack longitudinal axis stabilizer can contain an elastomer. This has the advantage that vibrations of the abutment do not pass through to the stack surface. The edges of certain bipolar plates or also distributors and frame elements on the stack surface can thus be protected from damage, and the service life of the fuel cell device can be increased.

Preferably, the shape and material of the stack longitudinal axis stabilizer is adapted to the structure of the fuel cell stack and the stack surface such that an acceleration a of 5 g, preferably 8 g, and particularly preferably 10 g orthogonal to the stack longitudinal axis does not lead to damage to the fuel cell stack. With knowledge of the invention, it is apparent to a person skilled in the art that a variety of options exist for corresponding adaptation of the stack longitudinal axis stabilizer to the structure of the fuel cell stack and the stack surface. These comprise, for example, selecting an elastic stack longitudinal axis stabilizer, selecting a large area on which the stack longitudinal axis stabilizer rests against the stack surface, adapting the contour of the stack longitudinal axis stabilizer to a contour of the stack surface, etc.

The stack longitudinal axis stabilizer preferably comprises a sliding contact surface. The abutment preferably comprises an abutment contact surface. The sliding contact surface can be arranged on the abutment contact surface. The abutment contact surface can define, together with the sliding contact surface, a sliding contact region running parallel to the stack longitudinal axis. As is clear from the context, the word component “contact” in the terms “sliding contact surface,”“abutment contact surface,” and “sliding contact region” stands for physical contact, not for electrical contact.

This causes a fuel cell stack stabilized by the stack longitudinal axis stabilizer to remain movable in the axial direction. A force acting along the stack, which can occur, for example, during a vibration of the vehicle, can thus be damped by a substantially reversible sliding movement in the sliding contact region. The edges of the bipolar plates can move back and forth in a sliding manner in the axial direction without being damaged. This can contribute, precisely in the case of a rather delicate stack, to an increase in the longevity of the fuel cell stack, so that maintenance intervals can be shortened, and particularly efficient vehicle operation can be continuously achieved.

One of the two surfaces referred to as an abutment contact surface and sliding contact surface can be a plastic surface, and the other of the two surfaces can be a ceramic surface. This promotes sliding of the sliding contact surface on the abutment contact surface.

In order to promote sliding of the sliding contact surface on the abutment contact surface, a means can be applied in the sliding contact region which promotes sliding of the sliding contact surface on the abutment contact surface.

A damping effect acting substantially along the stack longitudinal axis is thus achieved with the sliding contact region in addition to the stack longitudinal axis stabilizing effect acting substantially orthogonally to the stack longitudinal axis.

The stack longitudinal axis stabilizer can comprise, for example, an intermediate plate inserted into the fuel cell stack. A part of the intermediate plate preferably projects from the stack surface. This projecting part can form at least a part of the region of the stack longitudinal axis stabilizer which is arranged between the stack surface and the abutment.

The part, projecting from the stack surface, of the intermediate plate can be connected by a connecting element—for example, to a tension anchor element (functioning as an abutment) of the fuel cell device. Specific possibilities for connection are described below in connection with tension anchor stabilizers. This can have a synergistic effect on the stability of the fuel cell stack of the fuel cell device. This is because the connection of the intermediate plate to a tension anchor element leads not only to a stabilization of the stack longitudinal axis itself, but also to a stabilization of the tension anchor element against breakage described in more detail below.

It can be particularly preferred if a plurality of parts of the intermediate plate project from one or more stack surfaces. For example, at least a part of the intermediate plate can project from opposite stack surfaces.

A plurality of parts, projecting from the stack surface, of the intermediate plate can each be connected to a different tension anchor element of the fuel cell device.

The part, projecting from the stack surface, of the intermediate plate can be connected by a connecting element—for example, to a stack enclosure (functioning as an abutment). The connection can be electrically insulating, for example.

The connection can comprise a sliding bearing. For example, a connecting element can be mounted in a sliding manner on the abutment (for example, housing or system frame).

The abutment can comprise an adjustable abutment element. This can have the effect that manufacturing tolerances can be compensated for, thermal expansion of the intermediate plate can be absorbed and/or compensated for, and/or assembly of the fuel cell stack can be facilitated by transferring the adjustable abutment element from a first position to a second position.

The described abutment contact surface can, for example, be a surface of the abutment element. The described sliding contact surface can, for example, be a surface of a connecting element arranged on the intermediate plate. By adjusting the abutment element, it can be ensured that a desired sliding of the sliding contact surface on the abutment contact surface of the adjustable abutment element occurs in the sliding contact region.

The connection of the part, projecting from the stack surface, of the intermediate plate to the abutment can be realized by an elastic element (spring, elastomer, etc.). This is advantageous in particular with regard to the compensation for manufacturing tolerances and for thermal expansion of the intermediate plate.

One possibility consists in supporting the part, projecting from the stack surface, of the intermediate plate on the housing or on the system frame via the connecting element.

An anode region defined by an anode-side element can be arranged, e.g., welded, on one side of the intermediate plate.

A cathode region defined by a cathode-side element can be arranged, e.g., welded, on one side (the other side) of the intermediate plate. With the aid of the anode-side and cathode-side elements, it can be achieved that the surfaces of the intermediate plate in regions in which the seal rests have the shape of corresponding surface regions of the bipolar plates. The same sealing geometry as in the adjacent bipolar plates is thus achieved. In the transition of intermediate plate to bipolar plate, the same seal can then be installed as in the transition of bipolar plate to bipolar plate. This means that the fuel cell device can be assembled with particularly low effort.

A plurality of intermediate plates spaced apart from one another can be inserted into the fuel cell stack. A part of a plurality of intermediate plates, e.g., each intermediate plate, then preferably projects from the stack surface. Depending upon the length of the fuel cell stack, for example, a stack longitudinal axis stabilization and/or a stabilization of one or more tension anchor elements over a plurality of intermediate plates, which are inserted into the fuel cell stack at regular intervals, can be expedient.

The stack longitudinal axis stabilizer can preferably comprise a support element which supports the stack surface against the abutment.

The support element can be a sliding support element.

The abutment can comprise a carrier on which the sliding support element is guided so as to be slidable.

The described abutment contact surface can, for example, be a surface of the carrier. The sliding contact surface comprised by the stack longitudinal axis stabilizer can, for example, be a surface, facing the abutment contact surface, of the sliding support element.

One or more optional guide elements, e.g., guide rods, can extend parallel to the carrier. The one or more guide elements can, for example, extend through one or more openings of one or more sliding support elements.

The sliding support element can be guided on the carrier so as to be slidable with a return spring. During a sliding movement of the sliding support element on the carrier, the return spring can then promote a return of the sliding support element to the starting position.

Many, e.g., at least six, sliding support elements are preferably guided on the carrier so as to be slidable—for example, with return springs.

A floating bearing element can additionally be guided on the carrier.

On the stack surface, the fuel cell stack can have at least one contact region, on which at least one sliding support element can rest and support the fuel cell stack.

The shape of the contact region can be defined by one or more components of the fuel cell stack.

One or more bipolar plates can define the shape of the at least one contact region. One or more seals can define the shape of the at least one contact region. One or more bipolar plates and seals can jointly define the shape of the at least one contact region. Preferably, no fluid-conducting structures (for example, lines, hoses, and/or distributors) run in the contact region.

The at least one contact region can be adapted to the shape of the at least one sliding support element.

With the aid of the sliding support elements guided in this way, stabilization of the stack longitudinal axis can be achieved in that the stack surface is supported by the sliding support elements against a carrier functioning as an abutment. At the same time, the return spring can damp movements of the cell edges, resting against the sliding support elements, in the direction of the stack longitudinal axis. This can contribute to a further stabilization of the fuel cell stack.

By means of the sliding support element and its sliding contact region, a damping effect acting substantially along the stack longitudinal axis is thus achieved in addition to the stack longitudinal axis stabilizing effect acting substantially orthogonally to the stack longitudinal axis.

The abutment can be formed by a rail element running along a stack surface of the fuel cell stack. For example, the carrier described in conjunction with the sliding support element can be embodied as a rail element.

The rail element can be a tension anchor rail element. A tension anchor rail element is a rail element which simultaneously functions as a tension anchor element.

A buffer element can be arranged between the fuel cell stack and the rail element. The buffer element can, for example, contain an elastomer or a polymer foam. It can be an elastic, polymer foam-based buffer element.

A stack longitudinal axis stabilizer can run in a concave region of the stack surface of the fuel cell stack.

The buffer element can support a stack surface against the rail element and thereby effect a stack longitudinal axis stabilization. Movements of the fuel cell stack towards the rail element are damped by the buffer element.

The abutment contact surface described in more detail above can, for example, be a surface of the rail element. The sliding contact surface comprised by the stack longitudinal axis stabilizer can, for example, be a surface, facing the buffer element, of the sliding support element.

Also by means of the buffer element and its sliding contact region, a damping effect acting substantially along the stack longitudinal axis can thus be achieved in addition to the stack longitudinal axis stabilizing effect acting substantially orthogonally to the stack longitudinal axis.

On the stack surface, the fuel cell stack can have at least one contact region, on which at least one buffer element can rest and support the fuel cell stack.

The shape of the contact region can be defined by one or more components of the fuel cell stack.

One or more bipolar plates can define the shape of the at least one contact region. One or more seals can define the shape of the at least one contact region. One or more bipolar plates and seals can jointly define the shape of the at least one contact region. Preferably, no fluid-conducting structures (for example, lines, hoses, and/or distributors) run in the contact region.

The at least one contact region can be adapted to the shape of the at least one buffer element.

In certain embodiments, at least a part of the buffer element can be located in a concave region of the stack surface of the fuel cell stack, said region running parallel to the longitudinal axis of the fuel cell stack.

The rail element is preferably aligned parallel to the longitudinal axis of the fuel cell stack.

In a cross-section of the rail element, an extension of the rail element, which can be referred to, for example, as the height of the rail element, can be greater than a different extension of the rail element, which can be referred to, for example, as the width of the rail element. In this context, the terms width and height do not refer to the orientation of the rail element in relation to the direction of gravity. A cross-section is understood to mean an imaginary cutting surface of the rail element which would be obtained when cutting the rail element orthogonally to the longitudinal axis of the rail element.

This allows alignment of the rail element relative to the fuel cell stack such that the rail element is particularly flexurally rigid against forces acting from the fuel cell stack on the rail element.

The buffer element can be formed such that it partially (for example, in a U-shape) extends around the rail element in the cross-section between the rail element and the concave stack surface.

A surface, facing the stack surface, of the rail element can be wider than a surface, facing away from the stack surface, of the rail element. This offers the additional advantage that the contact surface of the rail element to the buffer element can be larger, so that even in the event of strong vibrations and impacts, a sensitive stack surface can remain undamaged due to the pressure distribution across a larger surface in the region of the adjacent buffer element. The cross-section of the rail element can be T-shaped, for example.

The rail element can, for example, replace a conventional tension anchor element with a round cross-section and stabilize the stack longitudinal axis of the fuel cell stack. Thus, it has only a minimal influence on the installation space and can effect a stack longitudinal axis stabilization particularly efficiently with minimal material effort.

If the rail element is used, for example, instead of a middle of three tension anchor elements, the tension anchor element can optimally develop its effect, for example, perpendicularly below a stack longitudinal axis. The specification “perpendicularly below” here refers to the direction of gravity.

The stack longitudinal axis stabilizer can comprise a support cushion element. The support cushion can be filled with air or foam, for example. The support cushion element can be arranged between the stack enclosure and the stack surface(s). This has the advantage of particularly simple assembly. One or more support cushion elements can preferably cover at least 5%, particularly at least 10%, and particularly preferably at least 25%, e.g., at least 50% of the total stack surfaces running parallel to the stack longitudinal axis. If the support cushion element is first filled (completely) at the surface of the fuel cell stack, the alignment of the fuel cell stack in the stack enclosure can be controlled by a predefined shape of the support cushion element. In addition, the enlargement of the surface is accompanied by a reduction in the surface pressure. This effects an advantageous load design and thereby a lower risk of damage in the region of the stack surface(s).

The stack longitudinal axis stabilizer can comprise a bulk material. The bulk material can be arranged between the stack enclosure and the stack surface. This allows particularly simple assembly. Since a large part of the space between stack surfaces and the stack enclosure can be filled with bulk material, the possibility arises of greatly reducing the ignitable volume in the event of a hydrogen leak, so that active ventilation of the space between the stack surface(s) and the stack housing may be unnecessary.

The stack longitudinal axis stabilizer can comprise a molded part. The molded part can preferably contain a polymer foam. A surface contour of the molded part can be adapted to the contour of the stack surface, for example. One or more molded parts can preferably cover at least 5%, particularly at least 10%, and particularly preferably at least 25%, e.g., at least 50% of the total stack surfaces running parallel to the stack longitudinal axis. A large-area support effect can be achieved in a particularly simple manner by one or more molded parts.

In contrast to the sliding support element described above and the buffer element, an additional damping effect acting substantially along the stack longitudinal axis with the support cushion element and the molded part is typically not effected by a sliding contact region, but, rather, by an intrinsic elasticity of the support cushion element or of the molded part.

A damping effect acting substantially along the stack longitudinal axis is thus likewise achieved with the support cushion element and/or the molded part in addition to the stack longitudinal axis stabilizing effect acting substantially orthogonally to the stack longitudinal axis. Optionally, this can even be achieved without the sliding contact region.

It can be particularly advantageous if a fixing region of the stack longitudinal axis stabilizer extends into a plate intermediate space—for example, a bipolar plate intermediate space of the fuel cell stack. The fixing region can preferably extend into an edge region of the plate intermediate space, wherein the edge region extends from the plate edge to a seal. For example, a support region of the stack longitudinal axis stabilizer can then form the region, arranged between the stack surface and the abutment, of the stack longitudinal axis stabilizer.

The abutment contact surface can then, for example, be a surface, facing the support region, of an abutment, e.g., a stack enclosure. The sliding contact surface can, for example, be a surface, facing the abutment contact surface, of the support region.

This offers further advantages compared to the stack longitudinal axis stabilizers described above. The support element (for example, sliding support element) described above, the buffer element described in connection with the rail element, the support cushion element, the bulk material, and the molded part each rest substantially on the outer contour of the fuel cell stack and can thereby strike the bipolar plate. It has been found that bipolar plates often are not perfectly stacked, and protruding bipolar plates may be subjected to special forces at the edges and may therefore possibly be damaged by such stack longitudinal axis stabilizers. In addition, sharp-edged bipolar plates can damage such stack longitudinal axis stabilizers, e.g., on their plastic surfaces, due to a cutting effect. In addition, many small particles are thereby generated and released.

In comparison thereto, the stack longitudinal axis stabilizers with an intermediate plate, also described above, can offer advantages. However, one or more intermediate plates require additional components which also have to be sufficiently mechanically stable and current-conductive. This can be accompanied by considerable additional weight.

The aforementioned disadvantages, which can accompany the stack longitudinal axis stabilizers described above, can be avoided in a particularly simple manner by the stack longitudinal axis stabilizer with the described fixing region. With the lowest possible component outlay, any disadvantages such as damage to bipolar plates at their edges or to stack longitudinal axis stabilizers can largely be avoided.

The stack longitudinal axis stabilizer, which comprises the fixing region and the support region, can be an elastomer element, for example. Due to the embodiment as an elastomer element, the characteristic of the force introduction is relatively “soft,” in contrast to a stop against a metallic element. In addition, tolerances in the outer contour of the fuel cell stack can thus be better compensated for, since claimed stack longitudinal axis stabilizers distribute the force, inter alia, over the fixing region to adjacent elements.

The fixing region can be clamped in the plate intermediate space by the two adjacent plates—for example, bipolar plates. A stable connection between the elastomer element and the adjacent plates can thus be achieved locally, which also withstands the introduction of a force from the outside in the direction of the cell plane.

Preferably, the average pressure exerted on the fixing region in the plate intermediate space by the two adjacent plates, e.g., bipolar plates, is higher than the average pressure exerted on the seal(s) in the plate intermediate space by the two adjacent bipolar plates.

This can be tested in that the seals and the fixing region are each compressed individually between the plates at the desired plate distance, the force required for this is measured, and the force applied in each case is converted into a pressure over the surface occupied by the seal or the seals and the surface occupied by the fixing region.

A proportion of at most 10%, preferably at most 6%, and particularly preferably at most 4% of a surface of a bipolar plate is preferably occupied by one or more fixing regions. Due to such a local embodiment, the total force applied for bracing the fixing region or the fixing regions remains relatively small in relation to the total stack bracing force. This can offer the great advantage that existing concepts for stack bracing can be largely retained.

Stack longitudinal axis stabilizers with a fixing region and support region, as described herein in a wide variety of embodiments, can thus, essentially, simply be added to an established fuel cell design, without further adaptations being necessary.

Furthermore, the local embodiment allows an arrangement of the elastomer element in a region in which the additional force can be well compensated for by the bracing system (see, for example, FIG. 34)—for example, in a region in which a spring element of an existing bracing solution comes to rest close to the edge of the pressure distributor plate. The spring element can in particular be a disk spring, compression spring, plate spring, or spiral spring.

To affix the fixing region on the plate surfaces in the plate intermediate space, at least one convex region can be formed on at least one of the surfaces of the fixing region and/or the plate that come into contact with one another.

A part of the fixing region can preferably be thickened on one or both sides. This means that the part is thicker than an adjacent part of the fixing region. When the fixing region is pressed in the plate intermediate space in the braced fuel cell stack, a compression of the fixing region then takes place in particular in the thickened region or the thickened regions.

A part of the surface of the bipolar plate, which surface comes to lie in the fixing region, can be thickened. When the fixing region is pressed in the plate intermediate space in the clamped fuel cell stack, a compression of the fixing region then takes place in particular where the distance from the next plate is particularly low.

The support region can preferably be embodied to be thicker in the direction of the stack longitudinal axis than the fixing region. The support region can, for example, comprise a shoulder which can extend over an edge surface of a bipolar plate. This can cause the shoulder to press onto the edge of a bipolar plate that protrudes slightly from a fuel cell stack that is not ideally stacked.

This can ultimately effect an additional stabilization of the fuel cell stack along the stack longitudinal axis, since local deviation from the ideal stack geometry can be counteracted in a particularly targeted manner. In addition, an abutment of the shoulder on the edge of the bipolar plate can cause the fixing region not to be pushed deeper into the plate intermediate space, where otherwise the sealing effect of a seal could be impaired. This means that the risk of H₂ leaks can be further reduced, and thus the operational safety of the fuel cell device can be increased even further.

The support region can be thicker in the direction of the stack longitudinal axis, e.g., even before bracing of the fixing region in the fuel cell stack (and the accompanying compression of the fixing region in the direction of the stack longitudinal axis), than the fixing region.

In the comparison of the thicknesses of the support region and the fixing region, the greatest thickness of both regions goes in the direction of the stack longitudinal axis in each case.

A plurality of convex regions can be formed on the fixing region. For example, a convex region closer to the support element and a convex region farther away from the support element can be formed. Optionally, one or more further convex regions can be formed between these two convex regions.

It can be particularly advantageous if the fixing region is embodied such that the force required for pressing the fixing region between the plates decreases towards edges of the fixing region. For this purpose, the fixing region can taper towards the edge of the fixing region. For example, the thickness of the fixing region can be smaller at a convex region closer to the support element and at a convex region farther away from the support element than the thickness of a convex region formed between these two convex regions.

Locally, significantly increased pressing forces can occur in the fixing region. In the case of an offset of the fixing regions of adjacent stack longitudinal axis stabilizers, this can lead to the introduction of bending moments into the adjacent bipolar plates. If thereby the sealing gap changes in the region of the adjacent seal, this could lead to an impairment of the sealing function. This effect of assembly tolerances can largely be avoided if the fixing region is embodied such that the pressing force decreases towards the edges of the fixing region—for example, due to a tapering occurring towards the edge of the region or a corresponding structuring of the surface. This can also be advantageous if, due to an assembly offset, collisions with features on a bipolar plate can occur.

It can be particularly advantageous if at least one seal and the stack longitudinal axis stabilizer are formed as a one-piece seal/stabilizer unit—for example, as a seal/stabilizer unit which has a seal, a fixing region, and a support region connected to the seal via the fixing region. This has the advantage that the seal and the stack longitudinal axis stabilizer do not need to be manufactured separately. In addition, fewer individual parts have to be installed during the production of the fuel cell device.

The object is also achieved by a seal/stabilizer unit for sealing successive reaction zones along the stack longitudinal axis of a fuel cell stack, wherein the seal/stabilizer unit has a seal, a fixing region, and a support region connected to the seal via the fixing region.

Of course, in particular the features of the stack longitudinal axis stabilizer, of its fixing region, and of its support region described herein can also be features of the seal/stabilizer unit.

The object is also achieved by a bipolar plate for a fuel cell stack, wherein an edge surface of the bipolar plate defines an edge support surface, whose width D measured orthogonally to the plate plane exceeds the bipolar plate material thickness. If the bipolar plate material thickness is not uniform, the average bipolar plate material thickness is taken into account for the comparison with the width D. If the width D is not uniform, the average width of the edge support surface is taken into account as the width D.

Preferably, D is at least 125% of the bipolar plate material thickness, particularly preferably at least 150%, and in particular at least 175%, e.g., at least 200%, of the bipolar plate material thickness.

The edge support surface can be bent or flanged, for example.

This adaptation of the edge surface can be used to prevent damage to the stack longitudinal axis stabilizer or the seal/stabilizer unit under vibration load. If the support region comprises a shoulder which extends over the edge surface of a bipolar plate, the enlarged width D can counteract the edge surface cutting into the shoulder of the support region.

However, the invention is not limited to the edge support surface—the width D of which, measured orthogonally to the plate plane, exceeds the bipolar plate material thickness—resting against a support region described herein.

The edge support surface can also allow a direct or almost direct support on the abutment, e.g., on the stack enclosure, and thereby effect stabilization of the stack longitudinal axis of the fuel cell stack.

Thus, the object is also achieved by a fuel cell device, wherein the fuel cell device comprises a fuel cell stack with at least one bipolar plate, wherein an edge surface of the bipolar plate defines an edge support surface whose width D measured orthogonally to the plate plane exceeds the bipolar plate material thickness, and wherein the stack longitudinal axis of the fuel cell stack is stabilized in that the edge support surface is arranged on an abutment—for example, on the stack enclosure.

The features indicated above with respect to the bipolar plate—in particular, with regard to the width D and the shape of the edge support surface—can, of course, also be features of the bipolar plate comprised by the fuel cell device.

The indication that the edge support surface is arranged on the abutment, e.g., on the stack enclosure, can mean that the edge support surface is supported on the abutment or that there is a small distance of the edge support surface which, for example, amounts to at most 5% of the length of the fuel cell stack along the stack longitudinal axis.

Particularly if the abutment itself is not an electrical insulator, the edge support surface is electrically insulated against the abutment. For this purpose, for example, a layer of an electrically insulating material can be arranged between the edge support surface and the abutment. Alternatively or additionally, an electrically insulating coating can be applied to the abutment and/or to the edge support surface.

The edge support surface can then directly form the sliding contact surface described herein, which in other embodiments of the invention is comprised by the stack longitudinal axis stabilizer. As described in connection with other embodiments, the abutment can comprise the abutment contact surface. The sliding contact surface can be arranged on the abutment contact surface. The abutment contact surface can define, together with the sliding contact surface, a sliding contact region running parallel to the stack longitudinal axis.

The edge surface of the bipolar plate can be oriented orthogonally to the plate plane, for example.

Orthogonal here means that the orthogonal elements (for example, the plate plane and the edge surface) run at an angle to one another which does not deviate from 90°, or at most by 20°—preferably at most by 10°.

According to the invention, it is also possible for a convex region of a bipolar plate, e.g., a plate projection region—preferably a plate projection region in the form of a tab—to extend into a recess of the stack longitudinal axis stabilizer. For example, two convex regions of a bipolar plate arranged on edge regions or edges or corners, arranged opposite one another, of a bipolar plate, e.g., plate projection regions, can be provided.

The convex region of the bipolar plate can also be a corner region of a bipolar plate—for example, a corner region of a substantially rectangular bipolar plate.

This embodiment of the stack longitudinal axis stabilizer reverses the above-described possibility of arranging a fixing region of the stack longitudinal axis stabilizer in a plate intermediate space. This is because, conversely, it makes it possible to arrange a convex region of the bipolar plate or a plate projection region in the recess of the stack longitudinal axis stabilizer.

The recess can be a slot.

The recess can be delimited by recess edge regions. The recess edge regions can, for example, limit the depth and length of the slot.

The recess edge regions can, for example, be adapted to the edge contour of the convex region of the bipolar plate. The recess edge regions can thereby be adapted in portions to the edge contour of the convex region of the bipolar plate or together form a recess edge region which is adapted continuously to the edge contour of the convex region. The recess edge region which is adapted continuously to the edge contour of the convex region can be adapted to the edge contour substantially over the entire length of the edge contour.

The support element of the stack longitudinal axis stabilizer can be formed by a region of the stack longitudinal axis stabilizer that protrudes beyond the plate projection region in the plane of the bipolar plate. At least one recess edge region can be located in the transition from the recess to the support element.

The stack longitudinal axis stabilizer can comprise a sliding contact surface. The sliding contact surface comprised by the stack longitudinal axis stabilizer can be a surface of the support element—preferably a surface of the support element located on the support element opposite to a recess edge region.

The sliding contact surface can rest against an abutment contact surface. The abutment contact surface can, for example, be an inner surface of a stack enclosure. Together with the sliding contact surface, the abutment contact surface then defines a sliding contact region running parallel to the stack longitudinal axis.

The convex region of the bipolar plate can be arranged in the recess in a force-locking and/or positive-locking manner.

The stack longitudinal axis stabilizer comprising the recess can be a plastic part. The plastic part can preferably be formed from a plastic material that can be molded by injection molding. The stack longitudinal axis stabilizer can be formed, for example, by overmolding the convex region of the bipolar plate with a plastic material.

The stack longitudinal axis stabilizer can be connected to the convex region of the bipolar plate by an undercut. In the convex region, the bipolar plate can have an indentation, for example. The stack longitudinal axis stabilizer can engage in the indentation. In the convex region, the bipolar plate can have an elevation, for example. The stack longitudinal axis stabilizer can extend around the elevation.

According to the invention, the object is also achieved by a bipolar plate for a fuel cell stack, wherein the bipolar plate comprises a convex region and a stack longitudinal axis stabilizer, e.g., a plate projection region—preferably a plate projection region in the form of a tab—wherein the convex region of the bipolar plate extends into a recess of the stack longitudinal axis stabilizer.

Of course, the stack longitudinal axis stabilizer comprised by this bipolar plate according to the invention and the convex region of the bipolar plate can have those features which are described herein. In particular, the above features of the recess, of recess edge regions, of the support region, of the sliding contact surface, and regarding the type of arrangement of the convex region in the recess, the material of the stack longitudinal axis stabilizer comprising the recess, the production of the stack longitudinal axis stabilizer comprising the recess, the connection via the undercut can also be features of the associated bipolar plate according to the invention.

According to the invention, the object is further achieved by a fuel cell device—in particular, for a locomotion means—wherein the fuel cell device comprises the following: a fuel cell stack and a cell suspension element that connects a cell of the fuel cell stack directly or indirectly to an abutment.

The cell suspension element can be arranged or formed on a component of the cell. The cell suspension element then connects the cell directly to the abutment. An example of such a component is a cell frame element that belongs to a cell frame of a single cell. A further example of such a component is a seal for sealing a cell.

However, the cell suspension element can also be arranged or formed on another component of the fuel cell stack—for example, on a component of the fuel cell stack which extends over a plurality of or between two cells. The cell suspension element then indirectly connects the cell to the abutment. An example of such a component is a bipolar plate, since it extends between two cells. A further example of such a component is a cell frame element that belongs to a frame bordering a plurality of cells.

Insofar as reference is made herein to “a cell” or “the cell” in connection with a cell suspension element—if the cell suspension element cannot be assigned to a particular cell—the cell next to the cell suspension element or either of two cells next to the cell suspension element is meant.

The cell suspension element is preferably formed on a cell frame element. The cell frame element can belong to a cell frame of a cell or also to a frame bordering a plurality of cells.

According to the invention, the cell suspension element connects the cell to the abutment. In this context, the word “connects” typically relates to mechanical connection.

In general, the cell suspension element connects the cell to the abutment such that the cell is mounted directly or indirectly on the abutment, the cell is directly or indirectly mechanically coupled to the abutment, and/or the freedom of movement of the cell relative to the abutment is at least limited.

Any connection known to a person skilled in the art can exist between the cell suspension element and abutment. The cell suspension element can connect the cell to the abutment—for example, in a force-locking, positive-locking, and/or integrally bonded—preferably force-locking and/or positive-locking—manner. The connection can comprise an undercut.

The cell suspension element is advantageously anchored in the abutment. Alternatively, the abutment can be anchored in the cell suspension element.

The cell suspension element can, for example, have a head region and a neck region. The head region can be affixed to the cell by the neck region.

A collar region can be formed on the abutment for anchoring purposes.

The collar region can, for example, be adapted to the dimensions and shape of the head region and neck region of the cell suspension element such that the neck region can come to rest in the collar region, but the head region rests on a side, facing away from the cell, of the collar region, so that the head cannot slip out of the collar region.

The head region is preferably received in the abutment by the collar region that extends towards the neck region.

However, the described embodiment with the head region, neck region, and collar region forms only one example for embodying the invention.

It is understood that the cell suspension element can also be anchored in the abutment in a different manner.

The abutment can, for example, have an abutment surface facing away from the cell. The abutment surface facing away from the cell can run parallel to the stack surface or be inclined relative to the stack surface. Reference is made here to the stack surface (running parallel to the stack longitudinal axis) which faces the abutment.

The cell suspension element can, for example, have a suspension surface facing the cell. The suspension surface facing the cell can run parallel to the stack surface or be inclined relative to the stack surface. Reference is made here to the stack surface running parallel to the stack longitudinal axis, which stack surface faces the cell suspension element.

The abutment surface facing away from the cell may extend into a region between the cell and the suspension surface facing the cell.

The abutment can have an abutment surface facing the cell. The abutment surface facing the cell can run parallel to the stack surface or be inclined relative to the stack surface. Reference is made here to the stack surface running parallel to the stack longitudinal axis, which stack surface faces the abutment.

In addition, the cell, e.g., the cell frame element, advantageously has a suspension surface facing away from the cell.

In interaction with the abutment surfaces, the suspension surfaces described here limit the movement of the cell suspension element into the abutment and out of the abutment. This is particularly clear on the basis of the specific exemplary embodiments shown in FIGS. 16 to 19 and described in more detail below.

The cell suspension element can connect the cell to the abutment via a damping element, for example. This can cause vibration decoupling. Moreover, a support or suspension of the fuel cell stack can be efficiently realized essentially without additional installation space.

The damping element can be formed and arranged such that a portion of the damping element extends into a region between one of the abutment surfaces and one of the suspension surfaces.

A portion can extend, for example, into a region between the abutment surface facing away from the cell and the suspension surface facing the cell. This portion can be referred to as a first portion and the region as a first region.

A portion can extend, for example, into a region between the abutment surface facing the cell and the suspension surface facing away from the cell. This portion can be referred to as a second portion and the region as a second region.

A particularly advantageous damping element can have a first and a second portion. The first portion can extend into the first region. The second portion can extend into the second region.

The fuel cell stack is then decoupled particularly efficiently from impact movements of the abutment, both when the impact leads to a movement of the abutment away from the cell and towards the cell.

The abutment can comprise a counter bearing. A cavity remaining in the region of the abutment and the cell suspension element can be completely or partially filled with a filling material. The filling material can, for example, contain a resin and/or an elastomer. This can be advantageous in compensating for tolerances and mechanically connecting the cell or the cell frame to the abutment—for example, the stack enclosure.

A suspension of any proportion of the cells of the fuel cell stack by cell suspension elements according to the invention is conceivable. For example, only a single cell of the fuel cell stack can thus each have an affixed cell suspension element, which connects the cell to an abutment.

This has the advantage that only individual cells have to be equipped with the cell suspension, and the remaining cells can be manufactured in a conventional manner. This can be advantageous—particularly in the case of stationary applications of the fuel cell device—if the abutment assumes a fixed position and is substantially not subjected to any vibrations or impacts. A suspension of the fuel cell stack by only a few cell suspension elements can then be sufficient to absorb the occurring forces.

It can be particularly advantageous if several cells of the fuel cell stack each have an affixed cell suspension element.

At least 10% of the cells or at least every tenth cell of the fuel cell stack can each have an affixed cell suspension element.

In particular, at least 20% of the cells or at least every fifth cell of the fuel cell stack can each have an affixed cell suspension element.

Preferably, at least 25% of the cells or at least every fourth cell of the fuel cell stack can each have an affixed cell suspension element.

Particularly preferably, at least 33% of the cells or at least every third cell of the fuel cell stack can each have an affixed cell suspension element.

Very particularly preferably, at least 50% of the cells or at least every second cell of the fuel cell stack can each have an affixed cell suspension element.

For example, each cell of the fuel cell stack can each have an affixed cell suspension element.

It is, for example, possible that the ratio of the number of cell suspension elements to the number of cells comprised by the fuel cell stack is 0.1 to 10—in particular, 0.2 to 5.

The higher the proportion of cells with a cell suspension element and/or the greater the mentioned ratio, the lower the forces acting upon individual cell suspension elements. A higher proportion of cells with a cell suspension element can allow individual cell suspension elements to be designed to be weaker. With knowledge of the invention, it is possible for a person skilled in the art to adapt the number and design of the cell suspension elements to the corresponding application of the fuel cell device. Thus, more cell suspension elements and those that are designed to be stronger can be advantageous for fuel cell stacks which are constructed from relatively heavy cells and which are subjected to relatively large vibrations during operation. On the other hand, a few cell suspension elements that are designed to be weaker can be advantageous for fuel cell stacks which are constructed from relatively light cells and which are subjected to no or to relatively low vibrations during operation.

The relatively high proportions of cells with a cell suspension element indicated above make a mechanical suspension on the abutment possible at the level of fewer cells or even at the individual cell level. The same applies if the ratio indicated above is 1 or more.

It can then be sufficient to form the cell suspension element or the cell suspension elements from an easily shapeable material of a cell frame element or a seal. A cell suspension element can thus be realized as a cell suspension element formed in one piece with a cell frame element or a seal, e.g., by casting—in particular, by injection molding.

According to the invention, the object is further achieved by a cell suspension frame element for a fuel cell stack—in particular, for a cell or a plurality of cells of a fuel cell stack, e.g., for one cell of a fuel cell stack, wherein the cell suspension frame element comprises a cell suspension element formed on a cell frame element.

Instead of the casting mold used conventionally for the casting, e.g., plastic injection molding, of cell frame elements, a casting mold expanded by regions for forming the cell suspension elements can be used to produce the cell suspension frame element.

The cell suspension frame element can be a plastic part—for example, a plastic injection-molded part.

It is understood that features of the cell suspension element described herein in connection with the fuel cell device can also apply to the cell suspension element formed on the cell suspension frame element.

By extending an injection-molded plastic frame or an injection-molded seal, i.e., in particular a seal obtainable by plastic injection molding, by one or more external cell suspension elements, a suspension of individual or all cells of the fuel cell stack at one or more abutments can be effected with minimal effort.

It is preferred if the cell or the cell suspension frame element has a plurality of cell suspension elements—in particular, at least two, and further preferably at least three, e.g., at least four, cell suspension elements.

The cell or the cell suspension frame element preferably has at most 32—in particular, at most 24, and further preferably at most 20, e.g., at most 16—cell suspension elements.

If the number of cell suspension elements is within these limits, the cell suspension generally withstands the usual mechanical loads, which are associated, for example, with impacts and vibrations during driving operation, without any problem.

In a preferred fuel cell device, a plurality of cells can each have a plurality of cell suspension elements.

The cell suspension elements are preferably oriented in different directions. A direction specified by a stack surface of the fuel cell stack is regarded as a direction here. In a fuel cell stack having a substantially rectangular cross-section, cell suspension elements can thus be oriented in up to four directions.

Particularly preferably, at least two cell suspension elements are oriented in opposite directions.

Very particularly preferably, at least three cell suspension elements are oriented in three different directions. This can create the possibility of a suspension on an abutment arranged above a fuel cell stack and at the same time on abutments arranged laterally on both sides of the fuel cell stack.

For example, four cell suspension elements can be oriented in four different directions. This can offer the additional possibility of a mechanical connection of the fuel cell stack to an abutment arranged below the fuel cell stack, so that forces acting for a short time upwards, which can occur, for example, when driving over speed bumps, can also be absorbed. A speed bump is in particular regarded as a structural elevation on the road which is arranged transversely to the direction of travel and leads to a speed damping, and is thus intended to contribute to traffic calming.

The abutment can be formed in any shape. For example, it can be a slot in a stack enclosure.

The abutment can preferably comprise a suspension counter-element. The suspension counter-element can, for example, be adapted to the cell suspension element such that the cell suspension element can connect the cell to the abutment in a force-locking, positive-locking, and/or integrally bonded manner via the suspension counter-element.

The suspension counter-element can, for example, be arranged on a stack enclosure.

The suspension counter-element can thus be a profile rail element, for example. The suspension counter-element or the profile rail element can, for example, have the abutment surface facing away from the cell.

The suspension counter-element or the profile rail element can comprise a leg which extends orthogonally to the closest stack surface.

The suspension counter-element or the profile rail element can comprise a leg which has the abutment surface facing away from the cell. The leg can extend parallel to the nearest stack surface.

The collar region formed on the abutment can be formed by two legs extending parallel to the nearest stack surface.

Certain profile rail elements can have an L-shaped profile cross-section.

The region between the fuel cell stack and the stack enclosure can be divided into a plurality of channel portions. For example, the cell suspension elements described here can be located between adjacent channel portions.

Equally, however, other elements described herein, e.g., a cell anchor stabilizer or a stack longitudinal axis stabilizer, can instead or additionally be located between adjacent channel portions—for example, a stack longitudinal axis stabilizer with a support region and fixing region.

In addition to the cell suspension, cell anchor stabilization, and/or stack longitudinal axis stabilization effect, this offers synergies—in particular, with regard to explosion protection of the fuel cell device.

In order to realize explosion protection in fuel cell devices, ventilation is frequently used. Here, air flows through the stack enclosure or the fuel cell housing in a targeted manner, and thus possibly occurring H₂ leakages are mixed into a non-critical mixture combination. In order to avoid the formation of dead water regions/regions of poor mixing, air baffles or flow guides may be necessary in conventional fuel cell devices. Depending upon the situation, this requires additional elements, which are costly to produce and install. This is because air baffles are expensive and must be mounted. The positions of the inputs and outputs of the ventilation are not freely selectable, and inputs and outputs must be positioned where it is useful in terms of flow/ventilation. Poor mixing/flow guides can be counteracted with higher ventilation volume flows, but at the cost of system efficiency.

As mentioned, the cell suspension elements described herein and/or a cell anchor stabilizer described herein or a stack longitudinal axis stabilizer described herein can be located between the adjacent channel portions. These channel portions can form a part of a ventilation system which is used to protect the fuel cell device from explosions. The ventilation system can connect, for example, at least one opening of the fuel cell device for supplying ventilation air to an outlet of the fuel cell device for discharging ventilation air.

A particular advantage thereby arises in that a cell suspension element and/or cell anchor stabilizer and/or stack longitudinal axis stabilizer located between the channel portions can at least partially replace an air baffle which is otherwise required for ventilation.

If a high proportion of the cells, e.g., at least 10%—preferably at least 20%, further preferably at least 25%, particularly preferably at least 33%, and very particularly preferably at least 50%—of the cells, each have at least one affixed cell suspension element and/or a stack longitudinal axis stabilizer, air baffles can be dispensable, and very good ventilation of the fuel cell device can nevertheless be achieved.

The channel portions can be defined completely or partially by the cell suspension elements.

The channel portions can be defined completely or partially by the cell suspension elements and/or at least one cell anchor stabilizer.

The channel portions can be defined completely or partially by the cell suspension elements and/or at least one stack longitudinal axis stabilizer (for example, in one of the embodiments with a support region and fixing region).

A channel portion can be delimited, for example, longitudinally with respect to the stack longitudinal axis by cell suspension elements, and transversely to the stack longitudinal axis by at least one cell anchor stabilizer or a stack longitudinal axis stabilizer.

The definition of channel portions completely or partially by cell suspension elements can allow efficient ventilation of a fuel cell housing without additional components, and also allow a geometrically more flexible design and positioning of the inlet and outlet of the ventilation.

Channel portions running parallel to one another and to the stack longitudinal axis can run on one or more stack surfaces. The ends of each of two adjacent channel portions can each merge into one another at one end of a stack surface. For example, a ventilation channel guided in a meandering manner around the fuel cell stack can thereby be formed. The possibility thus arises of forming the inlet and the outlet of the ventilation channel close to one another on the fuel cell device.

A further advantage of the defined channel portions is the spatial limitation of the flame front in the event of a fault, and thereby a reduction in the harmful effects of a mixture ignition occurring.

According to the invention, the object is also achieved by a fuel cell device which comprises one or more sensor elements for detecting a force and/or a change in the fuel cell device attributable to the effect of the force.

In particular, all fuel cell devices described herein can comprise one or more sensor elements for detecting a force and/or a change in the fuel cell device attributable to the effect of the force.

The one or more sensor elements can be designed for strain measurement, for stress measurement, or for path measurement. Such sensor elements are known to a person skilled in the art. For example, it can be a piezoelectric or electromagnetic sensor element.

Advantages, e.g., detection of critical states of the bracing system, arise due to the sensor element/sensor elements. For instance, the minimum bracing force being undershot or the maximum bracing force being exceeded, the detection of tilting, detecting bending along the stack longitudinal axis, etc. A possibility for deriving necessary measures, e.g., operating states, service requirements, etc., also arises.

At least one sensor element can transmit data to a data evaluation system. The data evaluation system can be configured to compare a target value with a measured actual value. It can also be configured, if necessary, to output an indication if the actual value deviates from the target value, or if the actual value deviates too far from the target value.

According to the invention, the object is also achieved by a fuel cell device—in particular, for a locomotion means—wherein the fuel cell device comprises the following: a tension anchor element; tension bracing elements, e.g., tension anchor plates, connected by the tension anchor element; and a tension anchor stabilizer, which, between the tension bracing elements, is in contact with the tension anchor element.

Of course, the fuel cell device can comprise one or more tension anchor elements, e.g., at least two—preferably at least four, and particularly preferably at least six—tension anchor elements.

Likewise, the fuel cell device can of course comprise one or more tension anchor stabilizers.

The tension anchor elements of a fuel cell stack can experience large bending vibration amplitudes in the event of resonance, and possibly break. The contact of the tension anchor stabilizer at least partially suppresses or damps the bending vibrations of the tension anchor element. Consequently, the risk of breakage of the tension anchor element is reduced.

In comparison with other technical solutions, e.g., tension anchors having a larger diameter, or bracing straps instead of tension anchor elements, the invention can be integrated in a particularly simple manner into conventional fuel cell devices braced with tension anchor elements.

An enlargement of the diameter of the tension anchor elements or the use of bracing straps instead of tension anchor elements would also entail considerable adaptation effort on other components of the fuel cell device. This can be avoided by the invention.

Any component with which a fuel cell stack can be clamped with the aid of tension bracing elements, e.g., tension anchor plates, can be considered as the tension anchor element. For example, it can be a tension anchor generally customary for this purpose.

The tension anchor element can also be a tension anchor rail element described elsewhere herein, for example.

According to the invention, the tension anchor stabilizer, between the tension bracing elements, is in contact with the tension anchor element—for example, tension anchor plates. The contact can be established in any way.

The term tension bracing element means in particular a tension anchor plate. However, the term tension bracing element is not limited to this, since the tension bracing function of a tension anchor plate can also be fulfilled, for example, by the wall of a stack enclosure.

The term tension anchor plate is to be understood functionally. Any component of a fuel cell device connected to a tension anchor element through which a tensile stress of the tension anchor element can be transmitted directly or indirectly to a fuel cell stack is a tension anchor plate. A sufficiently torsionally rigid, substantially lattice-like plate would also be conceivable, for example. The tensile stress can be transmitted directly, e.g., with the aid of a spring element, as shown by way of example in FIG. 15. For example, pressure distribution plates or force introduction plates can also be arranged between the tension anchor plate and the fuel cell stack.

With regard to the damping effect on a bending vibration, it is decisive that the contact with the tension anchor element exists at all. A deflection of the tension anchor element accompanying the bending vibration at the point at which the tension anchor stabilizer is in contact with the tension anchor element is made difficult solely by the contact with the tension anchor stabilizer.

The contact between the tension anchor stabilizer and the tension anchor element can be positive-locking, force-locking, and/or integrally bonded. It is preferably positive-locking and/or force-locking.

Preferably, the tension anchor stabilizer has a tension anchor attachment element.

A particularly preferred tension anchor attachment element is adapted to the shape of the tension anchor.

The tension anchor attachment element can be a snap connection element, for example. The tension anchor element can then be received in the snap connection element.

The snap connection element can have two gripping elements. The gripping elements can form a receiving region which is adapted to the shape of the tension anchor element. In the case of a rod-shaped tension anchor element with a round cross-section, the receiving region is preferably round. The inner diameter of the round receiving region can then be adapted to the outer diameter of the rod-shaped tension anchor element.

The gripping elements can define a tapered receptacle for the tension anchor element. At least one gripping element can elastically deform when the tension anchor stabilizer is affixed to the tension anchor element and can hook onto the tension anchor element in a releasable or non-releasable—preferably releasable—manner. Such elastic deformation of a joining part is customary in snap connections.

The tension anchor stabilizer can have an attachment securing element. This can be an element configured in any way, with which a tension anchor stabilizer attached in the tension anchor attachment element can be secured in the tension anchor attachment element. The attachment securing element can, for example, be an indentation or an opening through which the tension anchor stabilizer (for example, with a strap or a cable tie) can be fastened to the tension anchor element.

Typically, the tension anchor stabilizer is also in contact with at least one further component of the fuel cell device. The contact with the further component can be established in any way. A bending vibration amplitude of the tension anchor element in the contact region with the tension anchor stabilizer can then be damped more strongly. In addition, the bending vibration amplitude can also be damped by the other component which is also in contact with the tension anchor stabilizer.

The at least one further component can be selected, for example, from a further tension anchor element (or a plurality of further tension anchor elements), an intermediate plate inserted into the fuel cell stack of the fuel cell device (or a plurality of intermediate plates inserted into the fuel cell stack of the fuel cell device), and a stack enclosure.

A part, in contact with the tension anchor element, of the intermediate plate preferably projects from the stack surface.

The tension anchor stabilizer can in particular have a further attachment element. The further attachment element can, for example, be a further tension anchor attachment element or an intermediate plate attachment element.

This can allow bridging of the tension anchor element via the tension anchor stabilizer to the other component in a particularly simple manner. A reduction in the bending vibration amplitude is also achieved with minimal effort by the other component which is also in contact with the tension anchor stabilizer.

The fuel cell device can comprise, for example: a plurality of tension anchor elements, tension bracing elements, e.g., tension anchor plates, connected by the tension anchor elements, wherein the tension anchor stabilizer, between the tension bracing elements, is in contact with a plurality of tension anchor elements. The tension anchor stabilizer can advantageously be in contact with the tension anchor elements via tension anchor attachment elements—in particular, via snap connection elements. This has the advantage that the tension anchor stabilizer can then be clipped to the tension anchor elements in a very simple manner.

Advantageous tension anchor stabilizers have a plurality of tension anchor attachment elements and a stabilizer strut region, wherein the stabilizer strut region extends from tension anchor attachment element to tension anchor attachment element.

Two tension anchor attachment elements can be aligned such that the tension anchor stabilizer connects regions of two tension anchors, which regions are offset relative to one another, in the stack longitudinal direction. The two connected regions do not vibrate in-phase and with the same amplitude, due to the offset. The particular advantage therefore arises that an effective damping of bending vibrations is achieved even if both tension anchors are excited or vibrate in-phase.

A connection of regions of two tension anchors offset relative to one another in this way is achieved, for example, when a plurality of tension anchor attachment elements coincide with the corners of a triangle or a quadrilateral.

The tension anchor stabilizer can, for example, have at least three tension anchor attachment elements, wherein at least three of the tension anchor attachment elements coincide with the corners of a triangle—preferably a right triangle. It is then advantageous if the tension anchor stabilizer has a plurality of stabilizer strut regions which extend along at least two—preferably three—sides of the triangle from tension anchor attachment element to tension anchor attachment element.

The tension anchor stabilizer can, for example, have at least four tension anchor attachment elements, wherein at least four of the tension anchor attachment elements coincide with the corners of a quadrilateral—preferably a rectangle. It is then advantageous if the tension anchor stabilizer has a plurality of stabilizer strut regions which extend along at least three—preferably four—sides of the quadrilateral from tension anchor attachment element to tension anchor attachment element.

The tension anchor stabilizer can advantageously have a stabilizer strut region running inclined relative to the stack longitudinal axis. Particularly advantageously, it has a plurality of stabilizer strut regions which are inclined in opposite directions relative to the stack longitudinal axis.

For example, it can comprise a lattice region. The lattice region can comprise stabilizer strut regions which run in at least two different directions and intersect.

The lattice region can have, for example, a plurality of stabilizer strut regions running parallel to one another and inclined relative to the longitudinal stack axis. Particularly advantageously, it additionally has a plurality of stabilizer strut regions running parallel to one another and inclined in opposite directions relative to the stack longitudinal axis.

The tension anchor stabilizer can additionally be in contact with a tension bracing element—for example, a tension anchor plate. It can also be in contact with a further tension bracing element—for example, a further tension anchor plate. This provides a simple possibility of preventing the tension anchor stabilizer from slipping along the tension anchor elements.

The tension anchor stabilizer can have an intermediate plate attachment element.

The tension anchor stabilizer can, for example, have a tension anchor attachment element and an intermediate plate attachment element. A tension anchor element can be received in the tension anchor attachment element. Furthermore, a part, which is in contact with the tension anchor stabilizer, of an intermediate plate can be received in the intermediate plate attachment element.

The intermediate plate can be received in the fuel cell stack.

A further bearing of the tension anchor element thus arises between the tension bracing elements, e.g., tension anchor plates. A (further) reduction in bending vibrations of the tension anchor element can thereby be effected.

The intermediate plate attachment element can have any shape which is suitable for attaching to an intermediate plate. The intermediate plate attachment element is preferably a snap connection element.

The object is also achieved according to the invention by the use of a connecting element having
two tension anchor attachment elements or
a tension anchor attachment element and an intermediate plate attachment element
   as a tension anchor stabilizer of a fuel cell device.

The object is also achieved according to the invention by a tension anchor stabilizer for a fuel cell, having:
two tension anchor attachment elements or
a tension anchor attachment element and an intermediate plate attachment element.

Of course, the connecting element and the tension anchor stabilizer can have more tension anchor attachment elements and/or intermediate plate attachment elements than are explicitly mentioned here in connection with the use according to the invention and the tension anchor stabilizer according to the invention.

The intermediate plate attachment element can be aligned orthogonally to the axis of the tension anchor attachment element. The axis of the tension anchor attachment element coincides with the axis of the tension anchor element which can be attached by the tension anchor attachment element. The orthogonal alignment is preferred when the intermediate plate is flat.

Concrete design possibilities of the tension anchor stabilizer have been described in connection with the fuel cell device according to the invention. Of course, they also apply to the tension anchor stabilizer according to the invention discussed here and the use according to the invention of the connecting element discussed here, the structure of which can correspond to the tension anchor stabilizer.

The object is also achieved by an intermediate plate for a fuel cell stack, wherein an edge of the intermediate plate has a concave edge region, flanked by two convex edge regions, for receiving a tension anchor element, and a latching element, e.g., a latching head, for attaching an intermediate plate attachment element of a tension anchor stabilizer is formed on at least one convex edge region.

The intermediate plate can be connected to a tension anchor stabilizer for a fuel cell, said stabilizer having a tension anchor attachment element and an intermediate plate attachment element. The intermediate plate attachment element can be aligned orthogonally to the axis of the tension anchor attachment element.

The intermediate plate can be connected to the tension anchor stabilizer by a snap connection, wherein, for example, the intermediate plate attachment element is arranged on the latching element—for example, on a convex edge region, adjacent to the latching head, of the intermediate plate.

Features of the invention which are described in connection with a subject of the invention, i.e., for example, in connection with a specific fuel cell device according to the invention, can also apply to another fuel cell device according to the invention described herein.

Thus, the invention also relates to a fuel cell device which comprises a stack longitudinal axis stabilizer and a cell suspension element.

Thus, the invention also relates to a fuel cell device which comprises a stack longitudinal axis stabilizer and a tension anchor stabilizer.

Furthermore, the invention also relates to a fuel cell device which comprises a cell suspension element and a tension anchor stabilizer.

In addition, the invention also relates to a fuel cell device which comprises a stack longitudinal axis stabilizer, a cell suspension element, and a tension anchor stabilizer.

Further preferred features and/or advantages of the invention are the subject matter of the following description and the drawings illustrating exemplary embodiments.

### BRIEF DESCRIPTION OF THE DRAWINGS

FIGS. 1 and 2 schematically show the problem of a bending of a fuel cell stack;

FIG. 3 shows an intermediate plate for stack longitudinal axis stabilization;

FIG. 4 shows connecting elements;

FIG. 5 shows a schematic representation of a fuel cell device with an intermediate plate;

FIG. 6 shows a detail view of the structure of a fuel cell stack with an intermediate plate;

FIG. 7 shows a carrier with a sliding support element;

FIG. 8 shows a carrier with sliding support elements;

FIG. 9 shows another view of the carrier from FIG. 8;

FIG. 10 shows a stabilization along the stack longitudinal axis over a concave region of a stack surface;

FIG. 11 shows a fuel cell device with support cushion elements;

FIG. 12 shows a further fuel cell device with support cushion elements;

FIG. 13 shows a fuel cell device with bulk material;

FIG. 14 shows a fuel cell device with molded bodies;

FIG. 15 shows a fuel cell stack with locations for attaching sensor elements;

FIG. 16 shows a fuel cell stack in which the cell is connected to abutments by two cell suspension elements;

FIG. 17 shows a fuel cell stack in which the cell is connected to abutments by eight cell suspension elements;

FIG. 18 shows an embodiment of a cell suspension element with an abutment and a damping element;

FIG. 19 shows a further embodiment of a cell suspension element with an abutment, damping element, and counter bearing;

FIG. 20 shows a fuel cell stack with tension anchor stabilizers;

FIG. 21 shows another view of the fuel cell stack from FIG. 20;

FIG. 22 shows a fuel cell stack with tension anchor stabilizers;

FIG. 23 shows another view of the fuel cell stack from FIG. 22;

FIG. 24 shows a tension anchor stabilizer;

FIG. 25 shows another view of the tension anchor stabilizer from FIG. 24;

FIG. 26 shows a further tension anchor stabilizer;

FIG. 27 shows a fuel cell stack with tension anchor stabilizers;

FIG. 28 shows another view of the fuel cell stack from FIG. 27;

FIG. 29 shows another view of the fuel cell stack from FIGS. 27 and 28 with a view of a bipolar plate;

FIG. 30 shows an intermediate plate with tension anchor stabilizers;

FIG. 31 shows an enlarged section XXXI of FIG. 30;

FIG. 32-35 show a fuel cell stack with stack longitudinal axis stabilization via support elements and counter-elements;

FIG. 36 shows a cross-section of two bipolar plates with a one-piece seal/stabilizer unit;

FIG. 37 shows a cross-section of two bipolar plates with a seal and stack longitudinal axis stabilizer;

FIG. 38-40 show cross-sections of two metal bipolar plates with a one-piece seal/stabilizer unit;

FIG. 41 shows a cross-section of a bipolar plate in which a sliding contact surface is formed by an edge support surface; and

FIG. 42 shows a schematic representation of a plate projection region received in a recess of a stack longitudinal axis stabilizer.

The same or functionally equivalent elements are provided with the same reference signs in all figures.

### DETAILED DESCRIPTION OF THE DRAWINGS

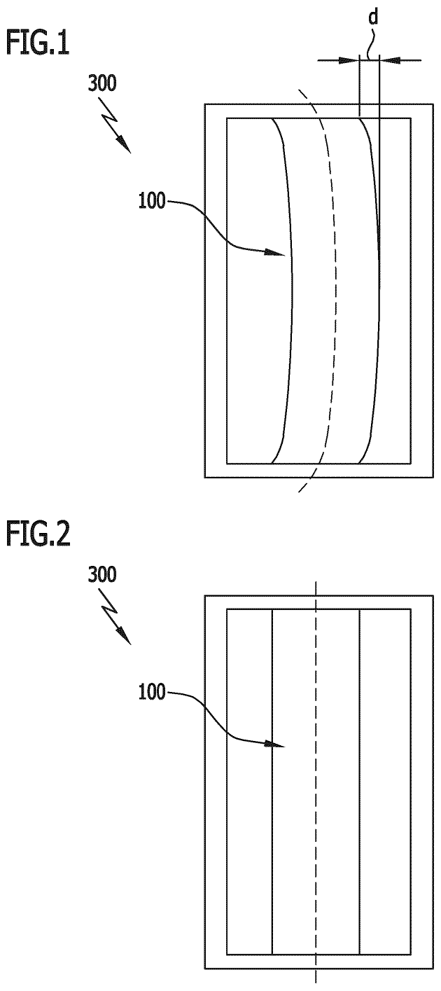

FIGS. 1 and 2 show a fuel cell device 300 in a highly simplified manner, which comprises a fuel cell stack 100. The dashed line shows a stack longitudinal axis of the fuel cell stack.

In particular if the fuel cell device 300 is installed in a locomotion means, e.g., in a motor vehicle, it can be subjected to impacts and vibrations.

The impacts and vibrations can lead to the fuel cell stack tending to bend along the stack longitudinal axis. A bending of the stack longitudinal axis is shown schematically in FIG. 1.

Depending upon whether the cells in the fuel cell stack are installed in the locomotion means in the horizontal or in the vertical direction, the bending of the fuel cell stack 100 along the stack longitudinal axis can arise, in particular, as a result of horizontal accelerations, e.g., during braking, accelerating, and/or cornering, or as a result of vertical accelerations—for example, when driving over potholes.

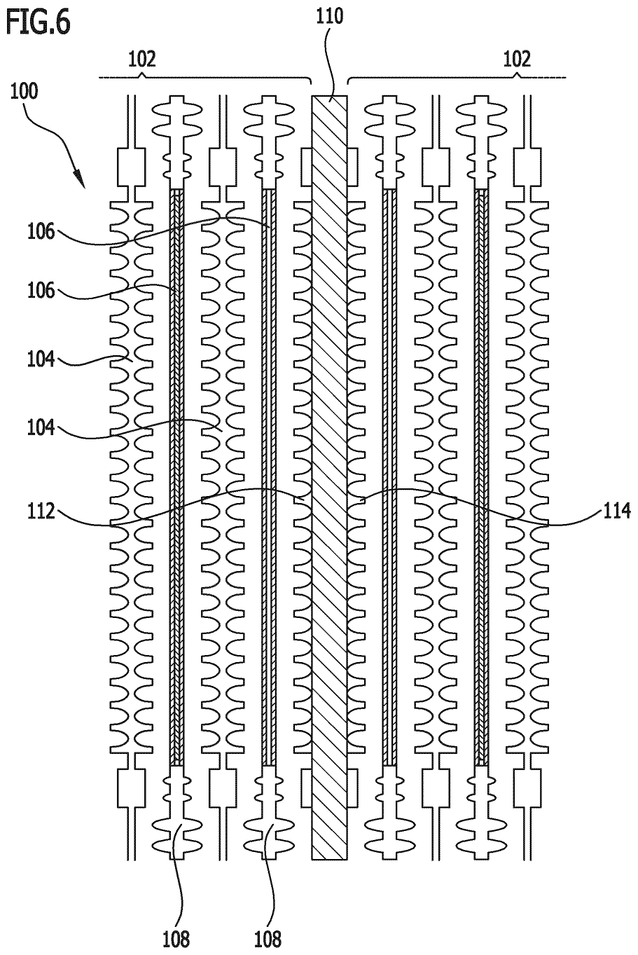

The undesired bending of the fuel cell stack 100 along the stack longitudinal axis can also be promoted by the fact that successive reaction zones in the fuel cell stack 100 are each sealed by seals 108 (cf. FIG. 6). The sealing materials also have a remaining compressibility in the clamped state, so that the bending stiffness of the fuel cell stack 100 along the stack longitudinal axis is relatively low. This is understood, for example, from FIG. 6, which shows that seals 108 are generally located at the edge between the bipolar plates 104.

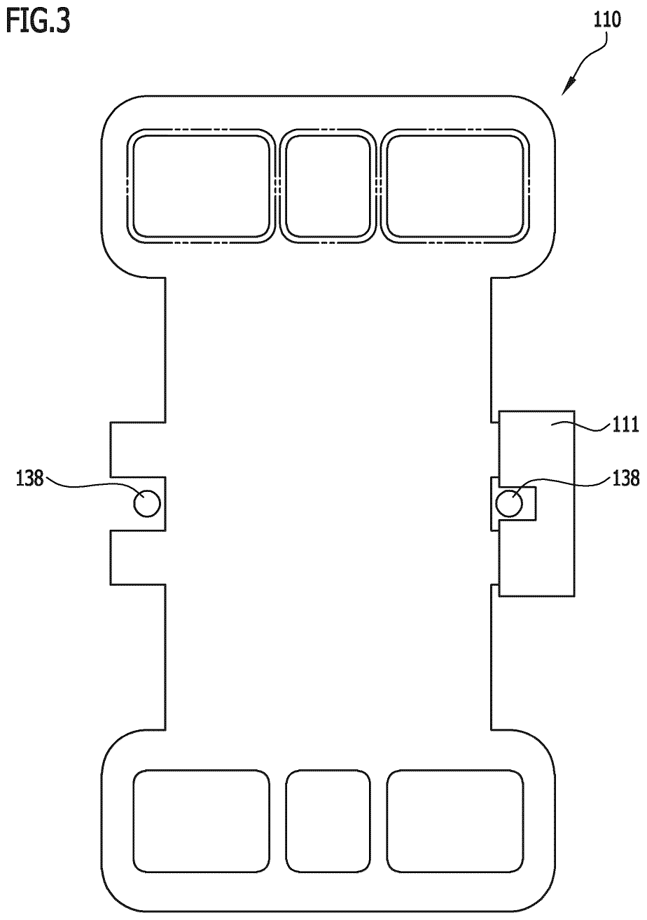

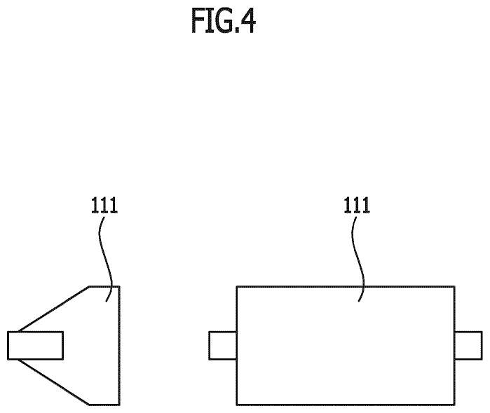

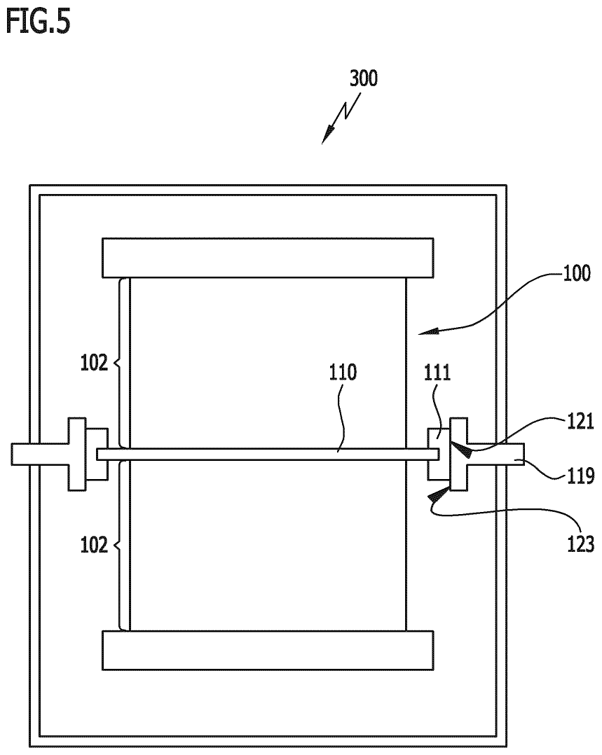

FIG. 3-6 illustrate embodiments for stabilizing the stack longitudinal axis by means of an intermediate plate 110. A basic structure is shown in FIG. 5. The fuel cell device 300 comprises a stack longitudinal axis stabilizer. In the embodiment shown here, the stack longitudinal axis stabilizer comprises an intermediate plate 110 inserted into the fuel cell stack 100. The intermediate plate 110 divides the fuel cell stack 100 into two fuel cell stack portions 102.

FIG. 5 clearly shows that a part of the intermediate plate 110 projects from the stack surface and thus is arranged between a stack surface of the fuel cell stack 100, said surface running parallel to the stack longitudinal axis, and an abutment. FIG. 5 also shows an attachment or support of the part, projecting from the stack surface, of the intermediate plate via a connecting element 111 on the housing or on the system frame.

The attachment comprises a sliding bearing. Connecting element 111 is mounted in a sliding manner on the abutment via the adjustable abutment element 119.

Mounting the fuel cell stack is facilitated by a transfer of the adjustable abutment element 119 from a first position to a second position.

A surface of the abutment element 119 forms an abutment contact surface 123. A surface of a connecting element arranged on the intermediate plate forms a sliding contact surface 121. By adjusting the abutment element, it can be ensured that a desired sliding of the sliding contact surface 121 against the abutment contact surface 123 of the adjustable abutment element 119 can occur in the sliding contact region.

Connecting element 111 can, for example, be a ceramic connecting element or a plastic connecting element.

The connecting element 111 can, for example, be affixed to the intermediate plate by an elastic intermediate element (not shown here).

The type of attachment of the fuel cell stack to the abutment shown in FIG. 5 offers further advantages—for example, high electrical insulation, the compensation for manufacturing tolerances, and thermal expansion of the intermediate plate (inter alia, due to the elastic intermediate element).

A tension anchor element 138 can also function as an abutment (cf. FIG. 3).

Each part, projecting from the stack surface, of the intermediate plate 110 can be attached to a corresponding tension anchor element 138 or otherwise to an abutment by connecting elements 111 shown schematically in FIG. 3-5.

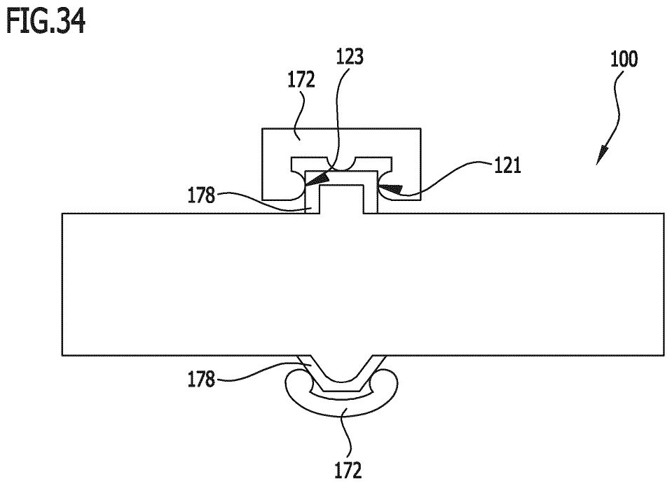

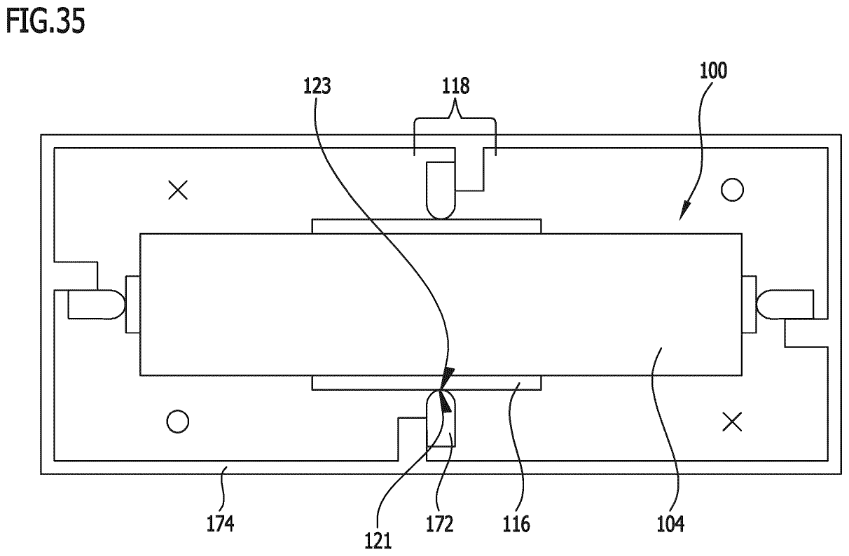

Possibilities for the structure of the intermediate plate 110 are clear in particular from FIGS. 3 and 6, wherein parts, projecting from the stack surface, of the intermediate plate are not shown in FIG. 6. As shown on the left in FIG. 3, two edges of the intermediate plate each have a concave edge region, flanked by two convex edge regions, for receiving a tension anchor element. The embodiment of the convex edge regions, for example, with a latching head 284 is conceivable, as described in more detail below in connection with FIGS. 30 and 31. In interaction with the intermediate plate 110, connecting elements 111 can thus simultaneously have a stabilizing effect on the tension anchor element.

FIG. 6 shows that the intermediate plate 110 can be thicker than the bipolar plates 104 in the two fuel cell stack portions 102. FIG. 6 also shows the position of membrane electrode units 106 between the intermediate plate 110 and adjacent bipolar plates 104, and between each two bipolar plates 104 and 104 in the two fuel cell portions 102 on both sides of the intermediate plate 110. The membrane electrode units 106 between the intermediate plate 110 and adjacent bipolar plates 104 can, for example, be membrane electrode units 106 having a 5-layer structure. The membrane electrode units 106 between bipolar plates 104, 104 can, for example, be membrane electrode units 106 having a 7-layer structure. Seals 108 are located at the edge between each of the successive plates 104 and 110 in the stack structure. For generating the sealing geometry, an anode region 112 and a cathode region 114 are welded onto the intermediate plate, so that the surfaces of the intermediate plate 110 in regions in which the seal 108 rests have the shape of corresponding surface regions of the bipolar plates 104.

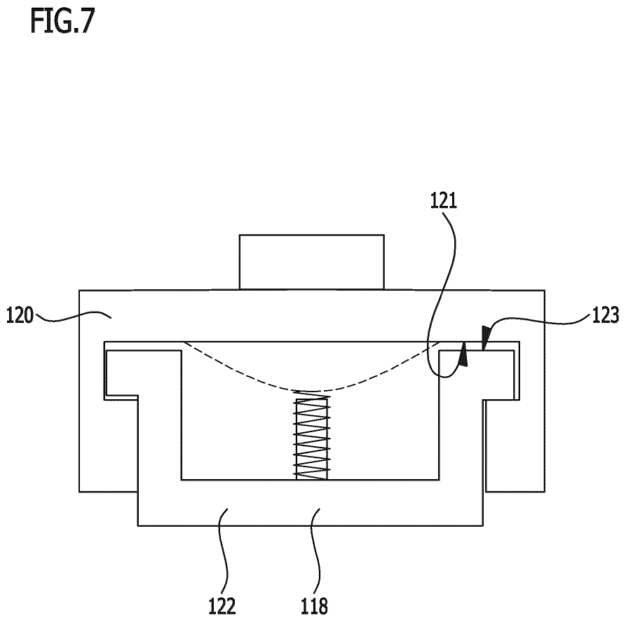

FIG. 7-9 show a further possible embodiment of a stack longitudinal axis stabilization for a fuel cell device. Here, a stack longitudinal axis stabilizer comprises a sliding support element 120 which supports the stack surface against a carrier 122 functioning as an abutment 118.

The sliding support elements 120 can, for example, rest directly on the outer contour of the cell. Preferably, at least a part of at least one sliding support element 120 is arranged in a region of a stack surface in which no fluid-conducting structures (for example, lines, hoses, and/or distributors) run.

FIG. 7 shows only a very small section of the cell outer contour resting on the sliding support element 120. It cannot thus be seen from FIG. 7 that the fuel cell stack can have one or more contact regions, against which the sliding support elements rest and support the fuel cell stack. The contact regions can be formed by one or more components of the fuel cell stack. One or more bipolar plates can also define the shape of one or more contact regions.

The spring indicated in FIG. 7 and the dashed line symbolize the elasticity of the material from which the sliding support element 120 is manufactured. By using a soft elastic material, the cell abutting it can be protected. In the event of vibrations and impacts, a damped force transmission distributed over the surface of the sliding support element to the stack surface or the edge of one or more adjacent cells occurs.

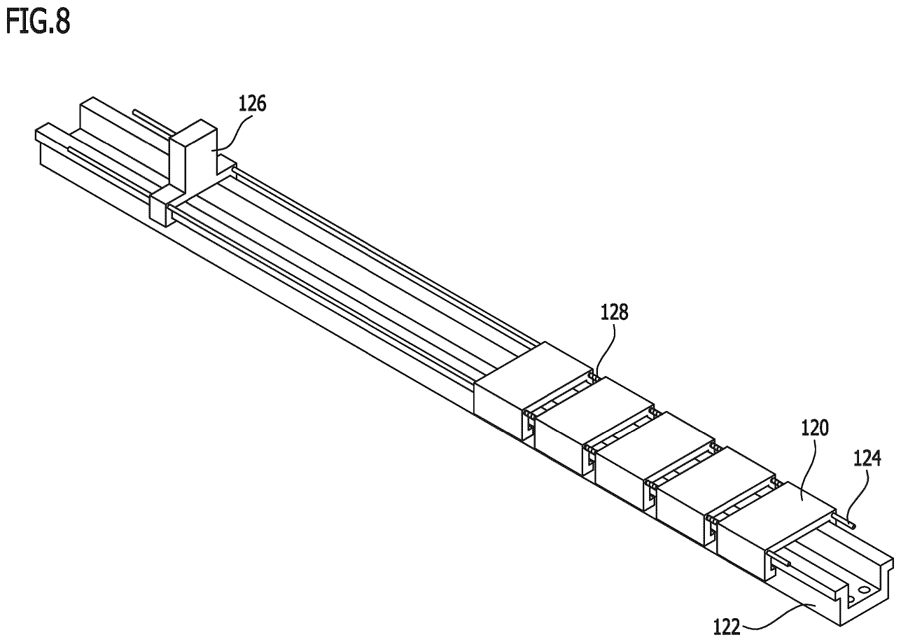

FIG. 8 shows that sliding support elements 120 and a floating bearing element 126 are guided so as to be slidable on the carrier 122. Guide elements 124, e.g., guide rods, extend parallel to the carrier 122 through the sliding support elements 120 and through the floating bearing element 126.

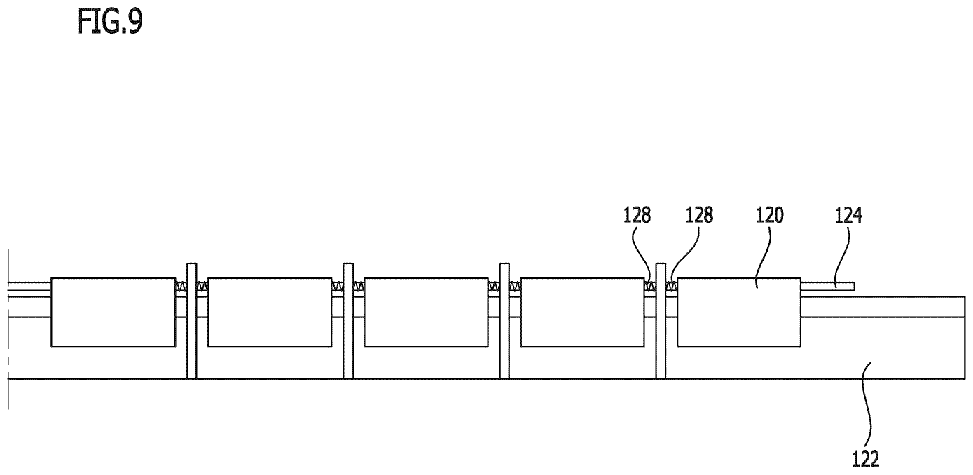

Springs 128, e.g., spiral springs, can be arranged around the guide rods and between the sliding support elements. These are shown in FIG. 9. The ends of the springs 128 remote from the sliding support elements 120 can be positioned on the guide rods by spring positioning elements shown in FIG. 9.

In this case, the abutment contact surface 123 is thus a surface of the carrier 122. The sliding contact surface 121 comprised by the stack longitudinal axis stabilizer is a surface, facing the abutment contact surface 123, of the sliding support element 120.

In the embodiment of FIG. 7-9, stabilization of the stack longitudinal axis thus arises in that the stack surface is supported against a carrier 122, functioning as an abutment, by the sliding support element 120. At the same time, the springs 128 damp movements of the cell edges, resting against the sliding support elements 120, in the direction of the stack longitudinal axis. This can contribute to a further stabilization of the fuel cell stack.

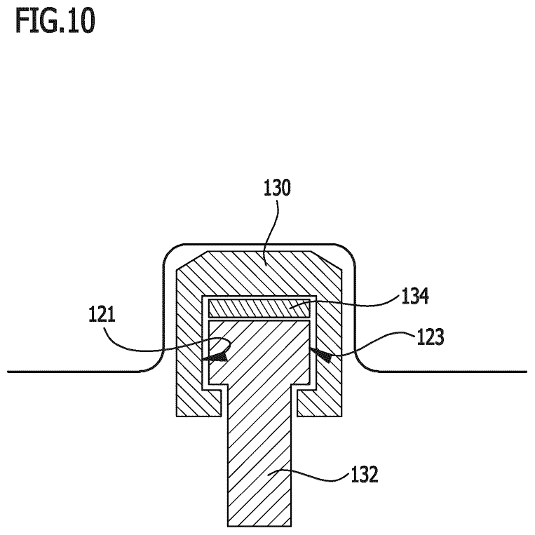

FIG. 10 shows an embodiment in which stabilization along the stack longitudinal axis takes place in a concave region of the stack surface of the fuel cell stack by a rail element 132 functioning as an abutment.

A cell contour is indicated in FIG. 10. An elastic buffer element 130—an elastomer buffer element—is arranged between the fuel cell stack and the rail element. In addition, a further element 134 can be arranged between the buffer element 130 and the rail element 132. The further element 134 can, for example, be a sliding element which promotes sliding of the buffer element 130 along the longitudinal axis of the rail element 132.

In this case, the abutment contact surface 123 is thus a surface of the rail element 132. The sliding contact surface comprised by the stack longitudinal axis stabilizer is a surface, facing the abutment contact surface 123, of the buffer element 130. In FIG. 10, not all abutment contact surfaces and sliding contact surfaces are provided with the corresponding reference signs.

The buffer element 130 is arranged between a concave region of the stack surface of the fuel cell stack 100, said region running parallel to the longitudinal axis of the fuel cell stack 100, and the rail element 132 functioning as an abutment. It is used to support the cell. The rail element can replace a tension anchor or a tension anchor element 138 of a conventional fuel cell device.

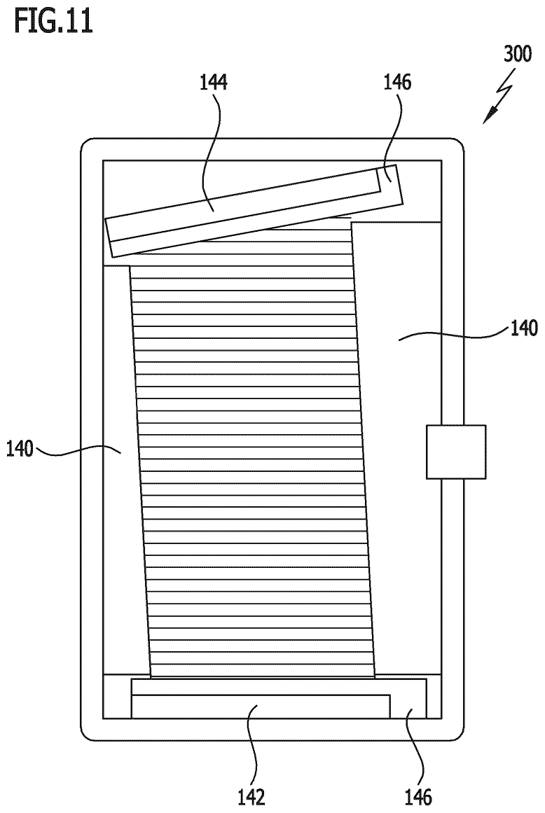

FIG. 11 shows an embodiment in which stabilization along the stack longitudinal axis takes place by means of support cushion elements 140. The support cushion elements 140 function as stack longitudinal axis stabilizers.

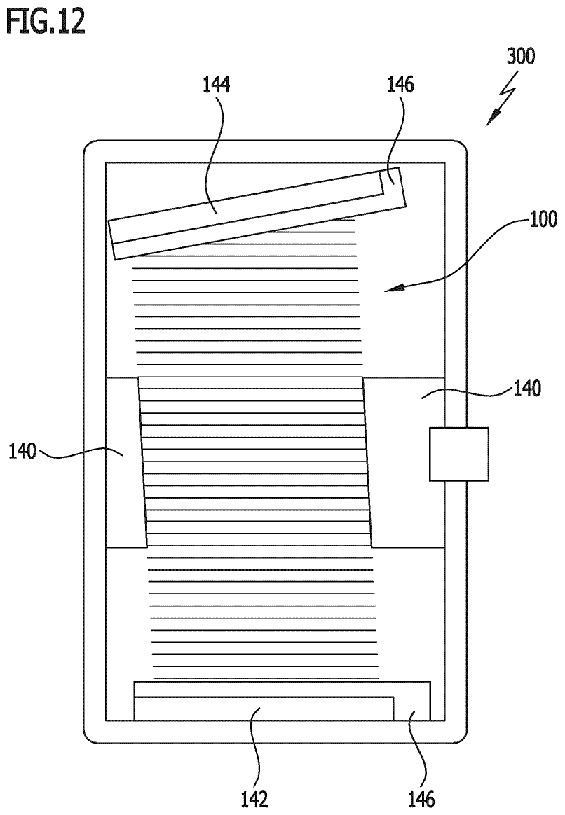

FIG. 12 shows a further embodiment in which stabilization along the stack longitudinal axis takes place by means of support cushion elements 140. The support cushion elements 140 function as stack longitudinal axis stabilizers. Deviating from the embodiment shown in FIG. 11, the support cushions shown here rest on the fuel cell stack only in a central region of the fuel cell stack 100.

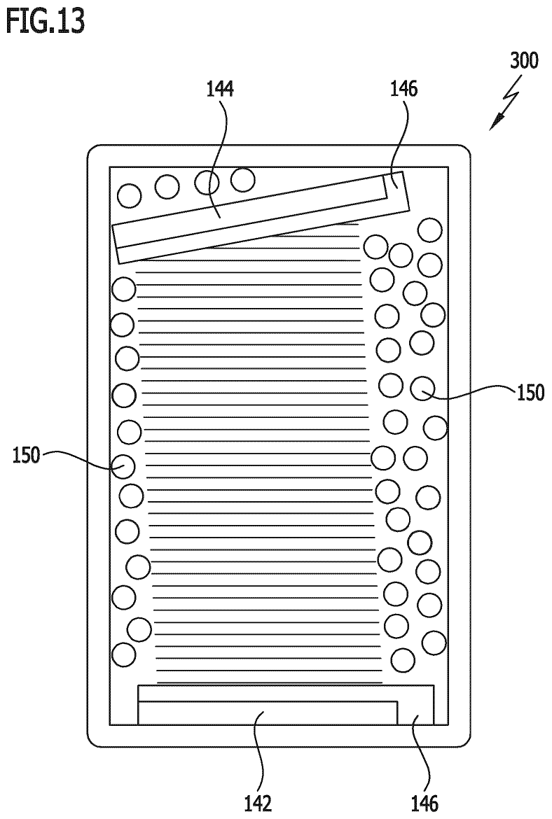

FIG. 13 shows an embodiment in which stabilization along the stack longitudinal axis takes place by means of bulk material 150. The bulk material 150 functions as a stack longitudinal axis stabilizer.

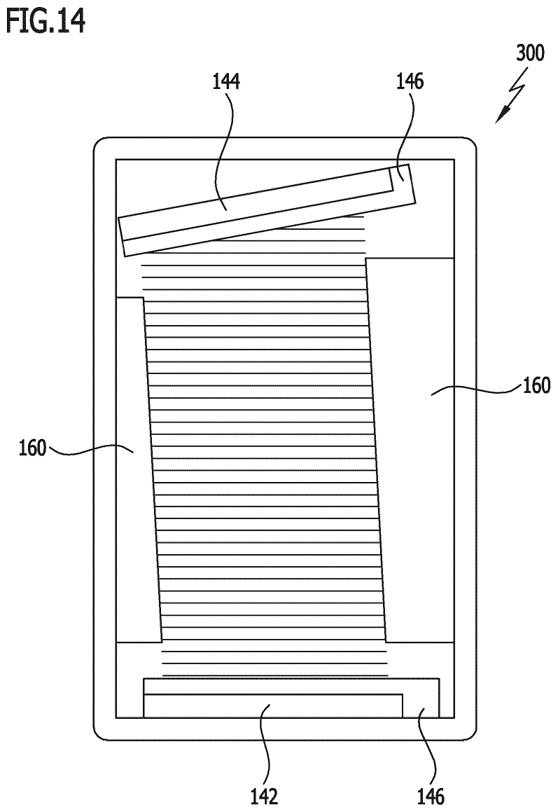

FIG. 14 shows an embodiment in which stabilization along the stack longitudinal axis takes place by means of molded parts 160. The molded parts 160 function as stack longitudinal axis stabilizers.

In the embodiments shown in FIGS. 11 to 14, the two ends of the fuel cell stack 100 each rest against a force introduction plate 146. The structure consisting of the fuel cell stack 100 and the two force introduction plates 146 is arranged between a tension anchor plate 142 and a pressure distributor plate 144.

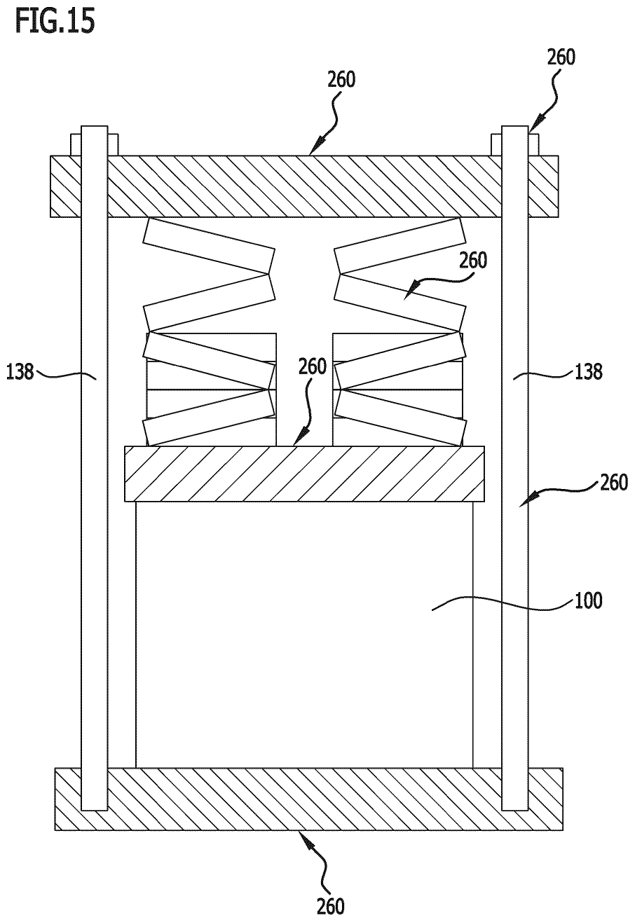

FIG. 15 shows locations of a fuel cell device 300. One or more sensor element(s) for detecting a force and/or a change in the fuel cell device 300 attributable to the effect of the force can be arranged at these locations. The arrows shown with reference sign 260 indicate these points, wherein the sensor elements themselves are not shown. As shown, the locations can be located, for example, on a tension anchor plate, on a tension anchor or on a tension anchor element, on a fastening nut of a tension anchor or of a tension anchor element, on a spring (in particular, on a disk spring arranged between the tension anchor plate and the pressure distributor plate), on a pressure distributor plate, and/or a fixed-bearing plate.

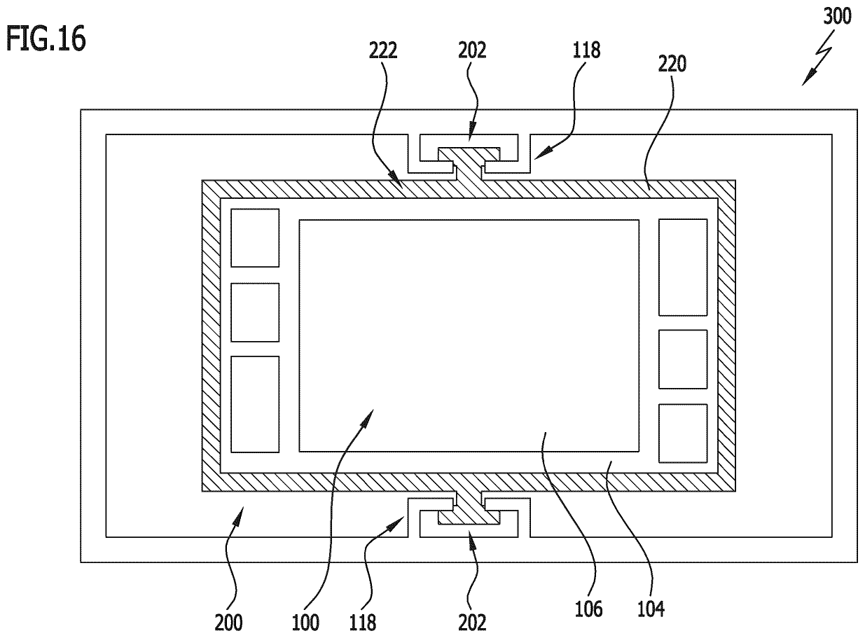

FIG. 16 schematically shows the interior of a fuel cell device 300, which comprises the following: a fuel cell stack 100, and a cell suspension element 202 affixed to a cell 200 of the fuel cell stack 100. The cell suspension element 202 connects the cell 200 with an abutment 118. The membrane electrode unit 106 likewise shown is part of the cell 200.

In the example shown here, the cell 200 comprises a cell suspension frame element 222. The cell suspension frame element 222 comprises the cell frame element 220 and the cell suspension element 202 formed thereon.

As can be clearly seen in FIG. 16, the cell suspension element 202 is anchored in the abutment 118.

FIG. 16 shows a cell 200 which has two cell suspension elements 202. The cell suspension elements 202 protrude beyond opposite stack surfaces of the fuel cell stack 100 (not shown in detail here).

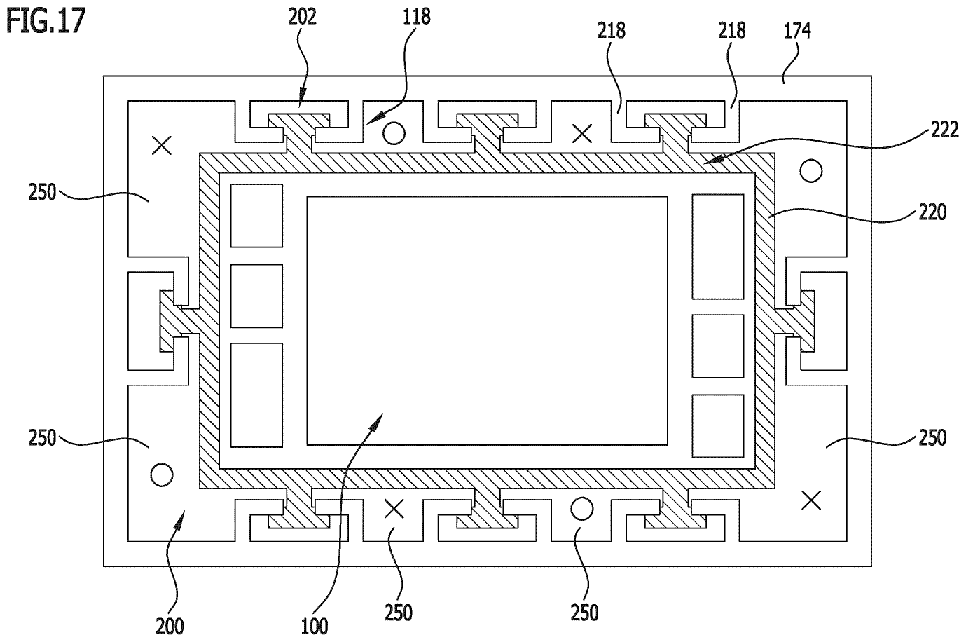

FIG. 17 schematically shows the interior of a different fuel cell device 300. Cells 200 of this fuel cell device differ from cells 200 of the fuel cell device shown in FIG. 16 essentially by a higher number of cell suspension elements 202 and corresponding abutments 118. Thus, FIG. 17 shows a cell 200 which has eight cell suspension elements 202. The cell 200 has a substantially rectangular cross-section. Three cell suspension elements are affixed to each of the two long sides of the cell 200. One cell suspension element is affixed to each of the two short sides of the cell. The cell suspension elements 202 protrude beyond opposite stack surfaces of the fuel cell stack 100 (not shown in detail here).

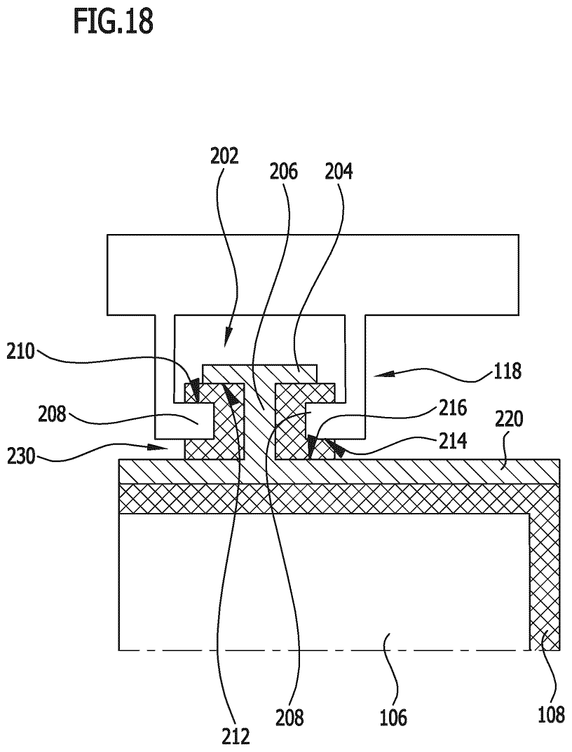

FIG. 18 shows a section of a further fuel cell device 300 in an enlarged representation, wherein a cell suspension element 202 connects the cell 200 to an abutment 118 via a damping element 230.

Some details of the connection of cell suspension element 202 and abutment 118 can be seen particularly well in the enlarged view of FIG. 18. They are therefore explained in the following on the basis of FIG. 18. However, the explanations also apply to embodiments without a damping element, as shown, for example, in FIGS. 16 and 17. Thus, the cell suspension element 202 has a head region 204 and a neck region 206. The head region 204 is affixed to the cell 200 by the neck region 206. In addition, FIG. 18 shows that a collar region 208 is formed on the abutment 118, and that the head region 204 is received in the abutment 118 by the collar region 208 that extends towards the neck region 206.

FIG. 18 also shows that the abutment 118 has an abutment surface 210 facing away from the cell 200, and that the cell suspension element 202 has a suspension surface 212 facing the cell 200. The abutment surface 210 extends into a region between the cell 200 and the suspension surface 212. Between the cell suspension element 202 and the abutment 108, there is thus a connection which comprises an undercut.

This limits sliding of the cell suspension element 202 out of the abutment 118.

The abutment 118 also has an abutment surface 214 facing the cell 200. Furthermore, the cell frame element 220 has a suspension surface 216 facing away from the cell. The suspension surface 216 extends into a region between the cell 200 and the abutment surface 214. This limits sliding of the cell suspension element 202 into the abutment 118.

In the embodiments of FIGS. 16 and 17, the abutment surface 210 facing away from the cell 200 is in contact with the suspension surface 212 in all abutments 118. There, abutment surfaces 210, 214 and suspension surfaces 212, 216 are each not provided with reference signs.

Looking at only one abutment 118 in FIGS. 16 and 17, sliding in of the cell suspension element 202 until the suspension surface 216 comes into contact with the abutment surface 214 would be conceivable. However, in the embodiments of FIGS. 16 and 17, the corresponding opposite cell suspension element 202 counteracts this, in that sliding of the cell suspension element 202 out of the abutment is prevented by the abutment surface 210 also being in contact there with the suspension surface 212.

In the embodiment of FIG. 18, a first portion of the damping element 230 extends into a region between the abutment surface 210 and the suspension surface 212. A second portion of the damping element 230 extends into a region between the abutment surface 214 and the suspension surface 216. In this embodiment, sliding of the cell suspension element 202 out of the abutment 118 is thus braked and ultimately stopped by a compression of the first portion of the damping element 230. Sliding of the cell suspension element 202 into the abutment 118 is braked and ultimately stopped by a compression of the second portion of the damping element 230.

The damping element 230 can contain an elastomer. It can be an elastomer bearing or an elastomer damper. This can be manufactured, for example, from a material which can be used for seals 108 described herein.

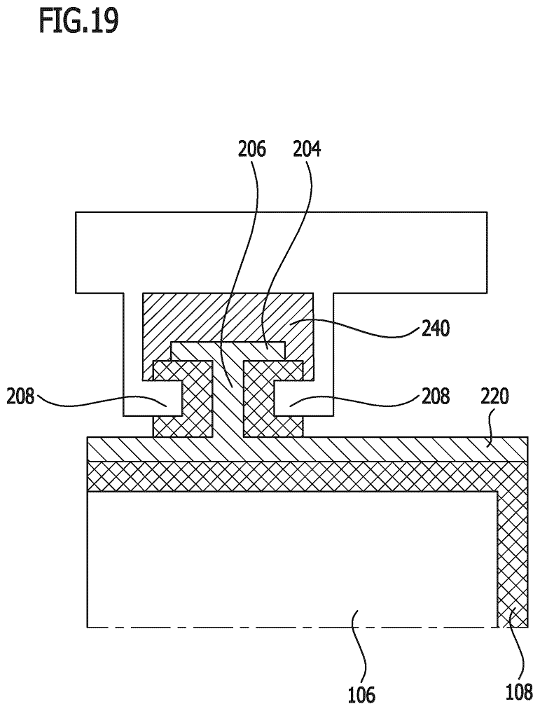

FIG. 19 shows an embodiment with a counter bearing 240 arranged on a side, facing away from the cell, of the cell suspension element 202. This counter bearing 240 can also counteract sliding of the cell suspension element 202 into the abutment 118. The counter bearing can, for example, be formed from a resin and/or elastomer, and/or can mechanically attach the cell suspension frame element 222 to the stack enclosure 174 via the cell suspension element 202.

In the embodiments shown in FIGS. 16 and 17, a plurality of cells 200 of the fuel cell stack 100 (preferably at least 10% of the cells 200 or at least every tenth cell 200 of the fuel cell stack 100, and particularly preferably at least 50% of the cells 200 or at least every second cell 200 of the fuel cell stack 100, e.g., every cell 200 of the fuel cell stack 100) can have cell suspension elements 202, which are affixed as shown in the corresponding figure for the cell 200 shown there.

In the embodiments of FIGS. 16 to 19, the abutment or the abutments 118 comprise suspension counter-elements 218. These are arranged on the stack housing 174.

If many cells 200 of the fuel cell stack 100 have cell suspension elements 202 which are affixed as shown in FIG. 17 for the cell 200 shown there, a region between the fuel cell stack 100 and the stack enclosure 174 is divided into eight channel portions 250. The cell suspension elements 202 are located between adjacent channel portions 250 and can delimit the channel portions 250 from one another.

The channel portions 250 can offer the particular advantage of better ventilation of the region between the fuel cell stack 100 and the stack enclosure 174. A gas flow, e.g., air flow, can be guided through the channel portions 250. It can be guided in a meandering manner around the stack surface, as indicated in FIG. 17 with symbols which show an inflow towards the observer and an outflow away from the observer. A formation of ignitable gas mixtures can thereby be avoided in the entire region, and thus the operational safety of the fuel cell device can be further increased.

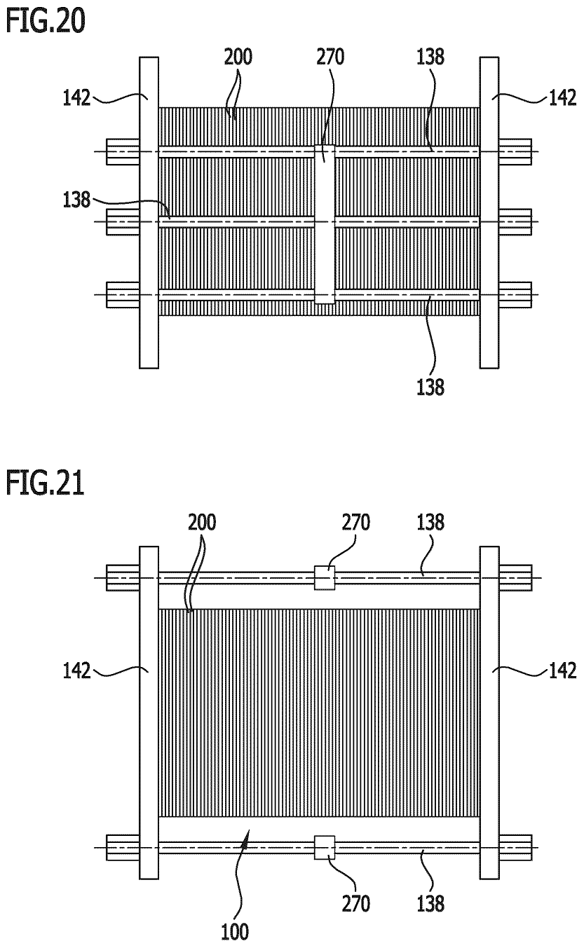

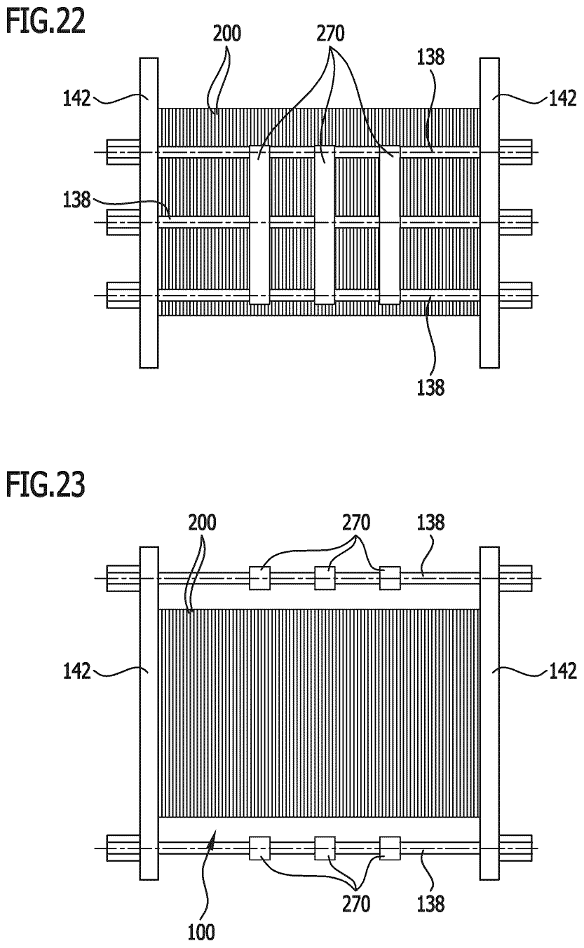

FIGS. 20 and 21 show a fuel cell stack 100 for a fuel cell device from different sides. This comprises: a plurality of tension anchor elements 138, tension anchor plates 142 connected by the tension anchors 138, and tension anchor stabilizers 270. The tension anchor stabilizers 270 are, between the tension anchor plates 142, each in contact with three tension anchor elements 138. Cells 200 are indicated in the fuel cell stacks 100 only as parallel lines.

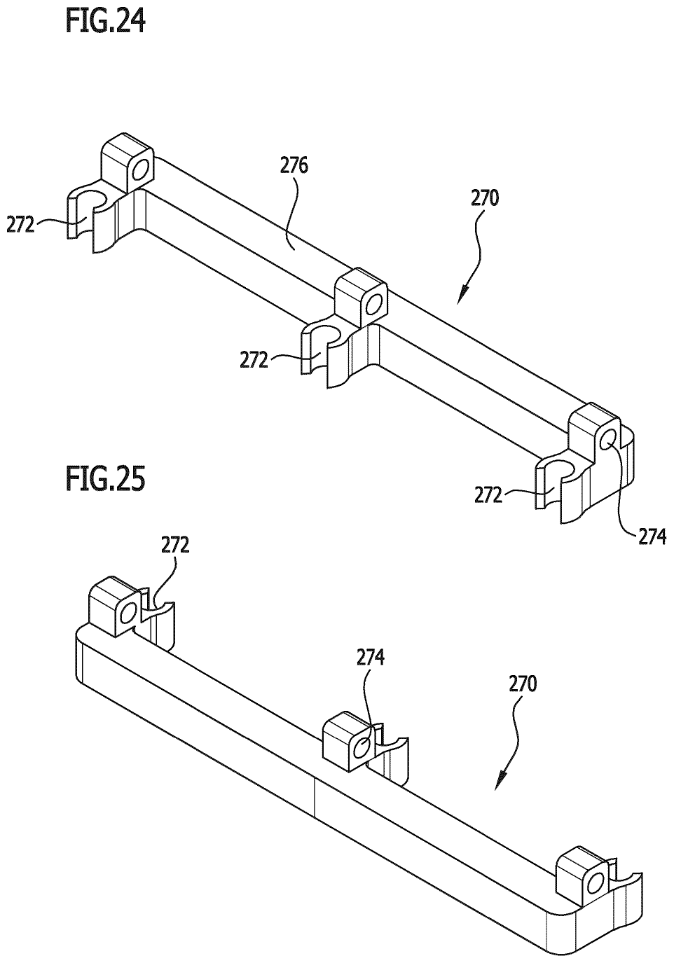

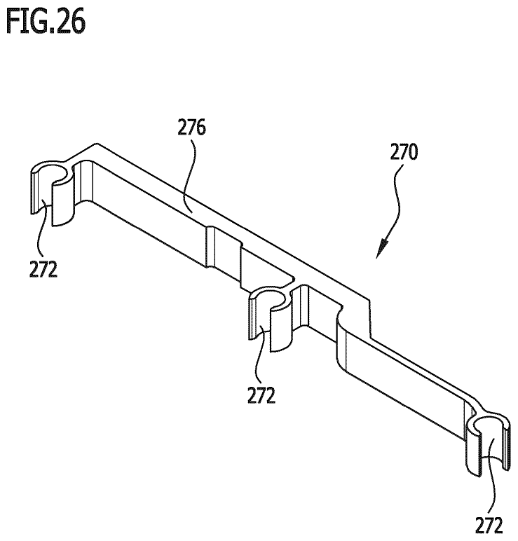

In the fuel cell stack shown in FIGS. 22 and 23, three tension anchor stabilizers 270 spaced apart from one another are, at two opposite stack surfaces, between the tension anchor plates 142, in contact with three tension anchor elements 138.

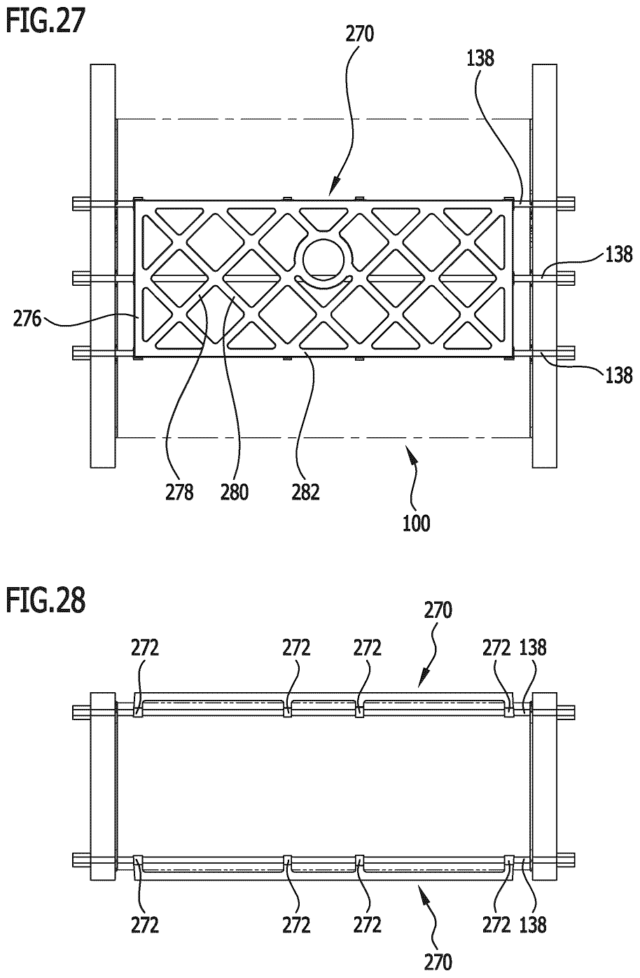

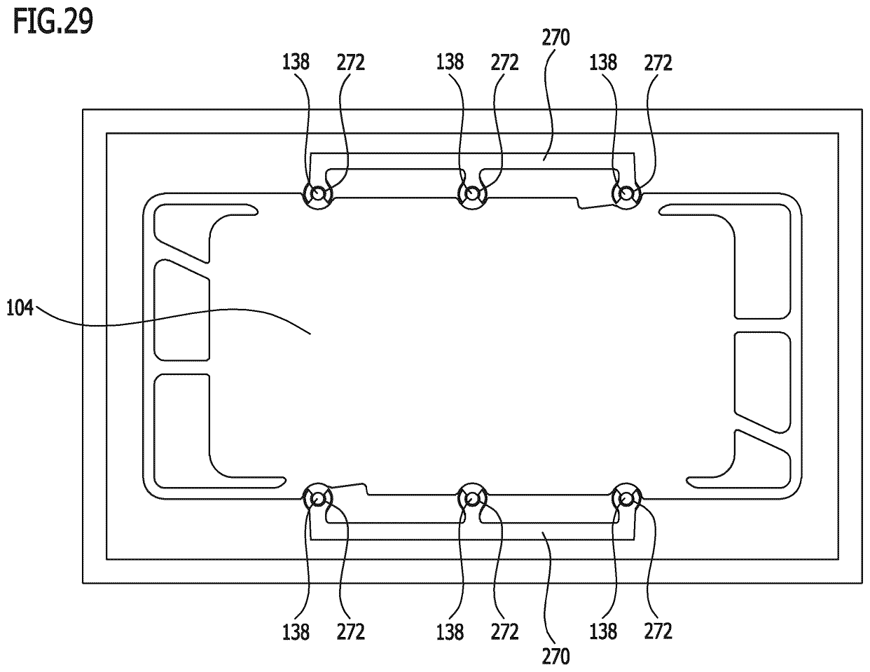

Details of the tension anchor stabilizer 270 shown in FIGS. 20 to 23 can be clearly seen in FIGS. 24 and 25. The tension anchor stabilizer 270 has three tension anchor attachment elements 272. A stabilizer strut region 276 extends from tension anchor attachment element 272 to tension anchor attachment elements 272. The tension anchor attachment elements 272 are adapted to the tension anchor shape. They each have two gripping elements which form a round receiving region for the round, rod-shaped tension anchor element 138, wherein the inner diameter of the round receiving region is adapted to the outer diameter of the round, rod-shaped tension anchor element 138. In the example shown here, the tension anchor attachment elements 272 are snap connection elements.

The tension anchor stabilizer shown in FIGS. 24 and 25 preferably has attachment securing elements 274 in the form of openings. Via these openings, the tension anchor stabilizer can be secured in the tension anchor attachment element 272—for example, with a cable tie.

The cable tie is guided through the opening and around the tension anchor element (not shown here) attached in the tension anchor attachment element 272.

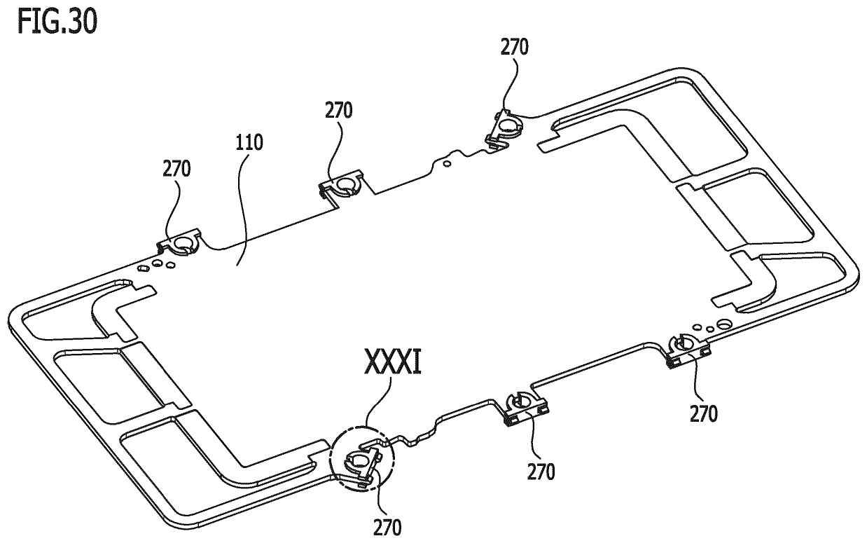

FIG. 26 shows another embodiment of a tension anchor stabilizer 270, in which a stabilizer strut region 276 also extends from tension anchor attachment element 272 to tension anchor attachment element 272. There, the tension anchor attachment elements 272 are likewise snap connection elements.

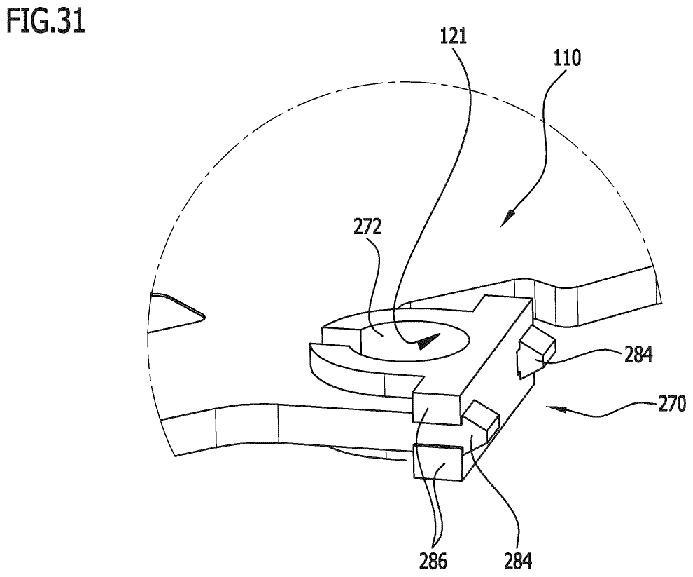

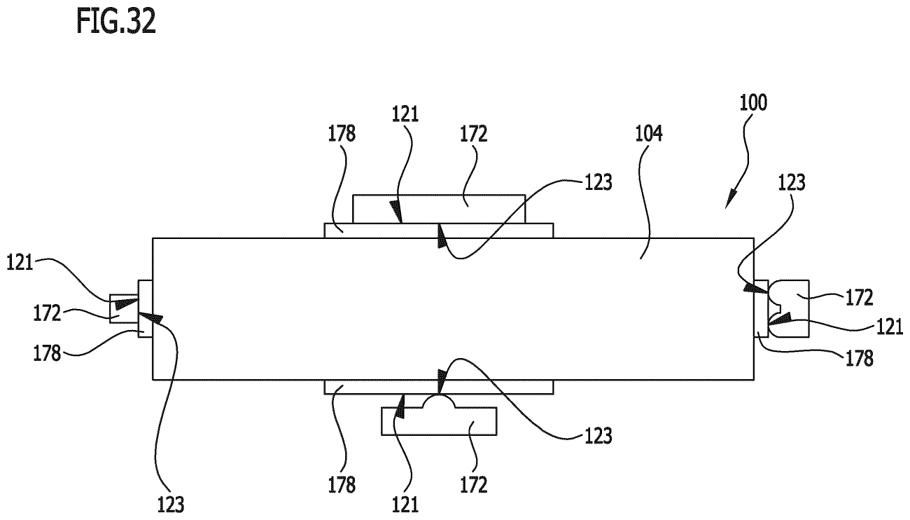

FIGS. 27 and 28 also show a fuel cell stack 100 for a fuel cell device from different sides.

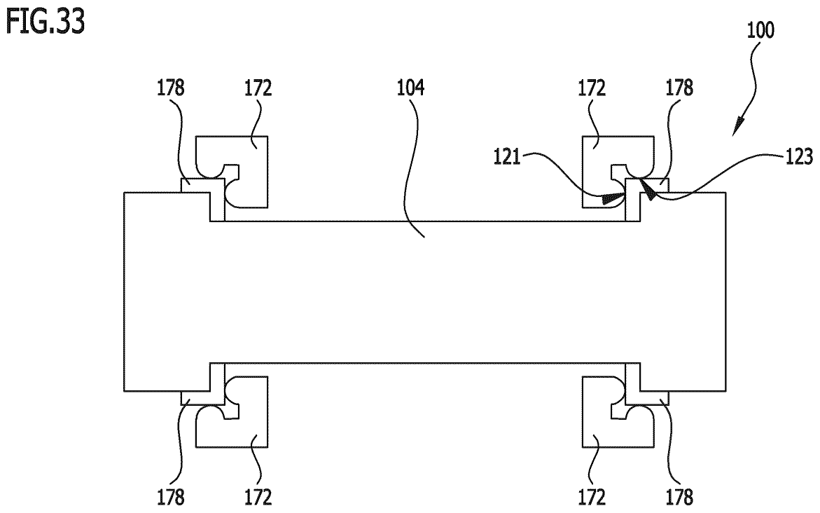

This also comprises: a plurality of tension anchor elements 138, tension anchor plates 142 connected by the tension anchors 138, and tension anchor stabilizers 270. The tension anchor stabilizers 270 are, between the tension anchor plates 142, in contact with the tension anchor element 138. FIG. 29 shows the same fuel cell stack 100 in a schematic view with a view onto a bipolar plate 104 in the interior of the fuel cell stack 100.

The two tension anchor stabilizers 270 shown in FIGS. 27 to 29 each have twelve tension anchor attachment elements 272, which are not all provided with reference signs in the figures and are partially covered by other tension anchor stabilizer regions. Four tension anchor attachment elements 272 of each tension anchor stabilizer 270 are in contact with a tension anchor element 138. The tension anchor attachment elements 272 are each embodied as shown in FIGS. 24 to 26.

It can also be clearly seen from FIGS. 27 and 28 that at least three of the tension anchor attachment elements 272 coincide with the corners of a right triangle. Many groups of three tension anchor attachment elements 272 which coincide with the corners of a right triangle can be identified among the tension anchor attachment elements 272. In some of these right triangles, stabilizer strut regions 276, 278, 280, 282 extend along at least two of the sides of the triangle from tension anchor attachment element 272 to tension anchor attachment elements 272. For example, the stabilizer strut regions 276, 280, and 282 thus run along three sides of a triangle in FIG. 27.

It can also be clearly seen from FIGS. 27 and 28 that at least four of the tension anchor attachment elements 272 coincide with the corners of a rectangle. Many groups of four tension anchor attachment elements 272 which coincide with the corners of a rectangle can be identified among the tension anchor attachment elements 272. For example, four tension anchor attachment elements 272 are located at the four corners of the tension anchor stabilizer 270. In the corresponding rectangle, four stabilizer strut regions extend along the four sides of the tension anchor stabilizer 270 from tension anchor attachment element 272 to tension anchor attachment element 272.

The tension anchor stabilizer 270 shown in FIGS. 27 and 28 also has, in addition to stabilizer strut regions 276 running perpendicular to the stack longitudinal axis, stabilizer strut regions 278 and 280 which run inclined relative to the stack longitudinal axis.

FIG. 30 shows tension anchor stabilizers 270 attached to an intermediate plate 110. FIG. 31 shows a detail view of a tension anchor stabilizer 270 from FIG. 30. The tension anchor stabilizer 270 shown in these figures has a tension anchor attachment element 272 and two intermediate plate attachment elements 286, wherein only the intermediate plate attachment element facing the observer is provided with reference sign 286. A tension anchor element 138 can be received in the tension anchor attachment element 272. A part, in contact with the tension anchor stabilizer 270, of an intermediate plate 110 is received in the intermediate plate attachment element 286. The two intermediate plate attachment elements 286 are snap connection elements.

The tension anchor stabilizer 270 clearly visible in FIG. 31 has a tension anchor attachment element 272 and an intermediate plate attachment element 286 aligned orthogonally to the axis of the tension anchor attachment element 272. The axis of the tension anchor attachment element 272 coincides with the axis of the tension anchor element 138 which can be attached by the tension anchor attachment element 272. Aligning the intermediate plate attachment element 286 orthogonally to the axis of the tension anchor attachment element 272 means that this axis is aligned orthogonally to the plate plane of an intermediate plate 110 that can be attached via the intermediate plate attachment element 286.

FIGS. 30 and 31 show the tension anchor stabilizer 270 on an intermediate plate 110. It is an intermediate plate 110 for a fuel cell stack 100. An edge of the intermediate plate 110 has a concave edge region, flanked by two convex edge regions, for receiving a tension anchor element 138. A latching head 284 is formed on each of the two convex edge regions. The latching heads 284 are each used to attach an intermediate plate attachment element 286 of the tension anchor stabilizer 270.

It cannot be directly seen from FIGS. 30 and 31 that, in a fuel cell stack 100 with the intermediate plate 110, a part, in contact with the tension anchor stabilizer 270, of the intermediate plate 110 projects from the stack surface. The sliding contact surface 121 comprised by the stack longitudinal axis stabilizer can be an inner surface of the tension anchor attachment element 272. The abutment contact surface (not shown here) is then a surface of the tension anchor element.

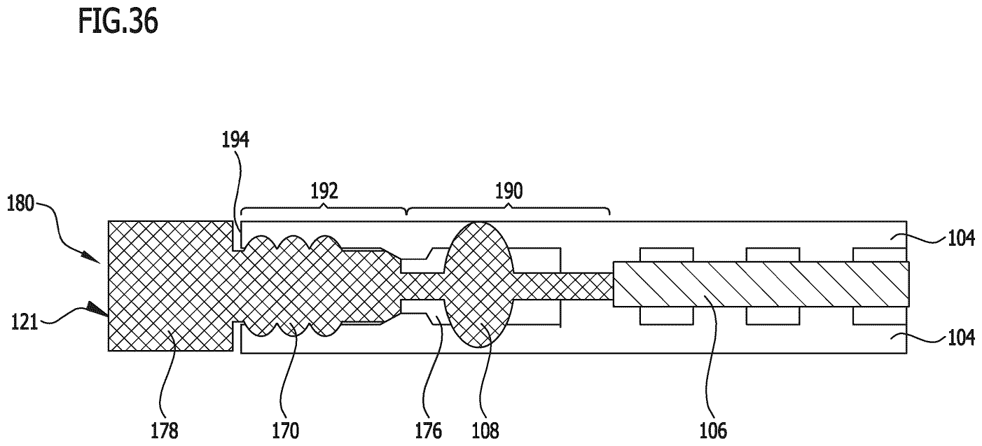

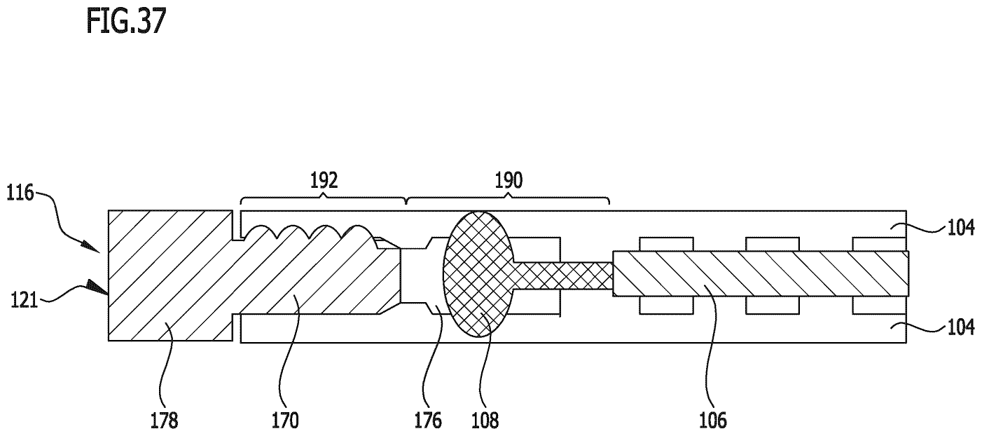

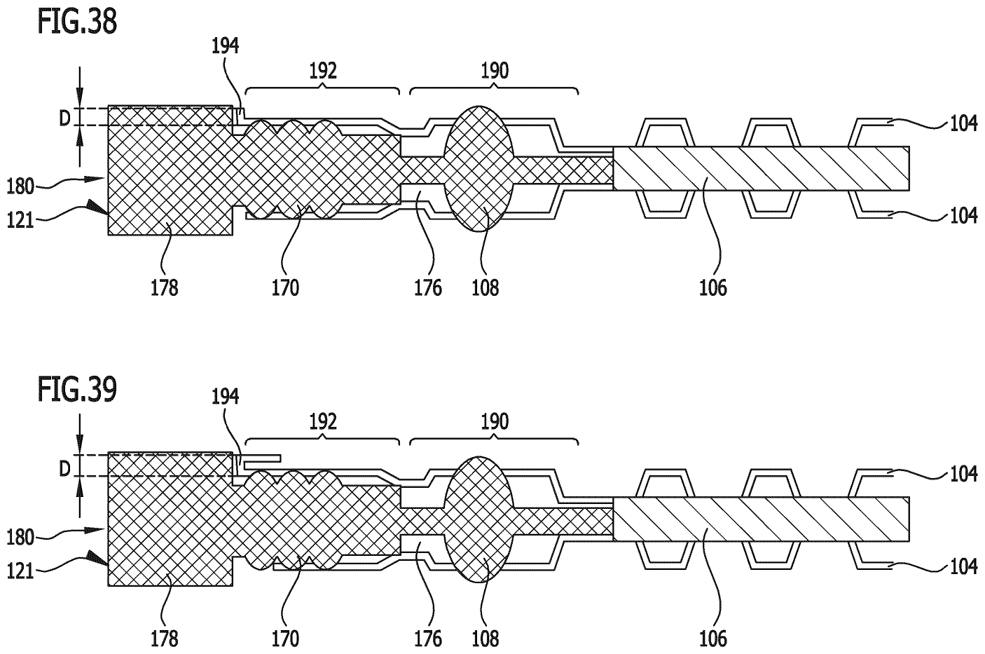

The embodiments shown in FIG. 32-40 are characterized in that a fixing region 170 (cf. FIG. 36-40) of a stack longitudinal axis stabilizer 116, made of an elastomer and/or a plastic (cf. FIG. 37), which can also be part of a seal/stabilizer unit 180 (cf. FIGS. 36, 38, 39, and 40), extends into a plate intermediate space 176 and is clamped in the plate intermediate space 176 by the two, adjacent bipolar plates 104, 104 (cf. FIG. 36-40).

Since FIG. 32 shows a fuel cell stack 100 with a view along the stack longitudinal axis onto a surface of a bipolar plate 104, the fixing regions 170 extending into plate intermediate spaces are covered by the bipolar plate 104.

FIG. 32 illustrates that support regions 178 of stack longitudinal axis stabilizers form regions which are arranged between the four stack surfaces and abutments which are not completely shown here. The abutment can, for example, comprise a part of the stack enclosure (not shown here). The abutment comprises counter-elements 172 which can press against the support regions 178 with a defined prestressing force, so that a deflection of the fuel cell stack 100 with respect to the stack longitudinal axis is made more difficult, and thereby stack longitudinal axis stabilization is achieved.

FIG. 32 also shows that counter-elements 172 can have many different shapes. A flat surface of a counter-element 172 can thus press flat against a flat surface of a support region 178. Contact can exist over a large area or a small area. Counter-elements 172 can also be curved and press against a surface of a support region 178 over one or more curvatures.

FIGS. 33 and 34 also show fuel cell stacks 100 with a view along the stack longitudinal axis onto a surface of a bipolar plate. Therefore, the fixing regions 170 extending into plate intermediate spaces of stack longitudinal axis stabilizers are also covered there by bipolar plate 104. Only the support regions of the stack longitudinal axis stabilizers can be seen and are provided with reference signs.

The bipolar plate 104 shown in FIG. 33 is widened at two opposite edges. Their contour resembles that of a bone. This results in additional corners arranged inwardly, which can be used for the stack longitudinal axis stabilization. The inwardly arranged corners offer a good mechanical attachment possibility for stack longitudinal axis stabilizers with fixing region 170 and support region 178. This is because the bipolar plates and seals are not interrupted there by distributors. In principle, the corners arranged outwardly are also suitable for mechanical attachment. Depending upon the load characteristics, fewer than four stack longitudinal axis stabilizers can also be sufficient for a plate intermediate space.

The bipolar plate 104 shown in FIG. 34 has on two opposite edges extension regions which protrude beyond the otherwise rectangular basic shape of the bipolar plate 104. Force peaks that could lead to bending along the stack longitudinal axis (cf. FIGS. 1 and 2) can be absorbed particularly well in these extension regions. Thus, these extension regions can be braced (along with the rest) between force introduction plates or end plates of the stack without an excessive punctiform compression of a seal of the fuel cell stack thereby taking place at the same time.

Deviating from the bipolar plates 104 shown in FIGS. 33 and 34, those of the fuel cell stack 100 shown in FIG. 35 have a rectangular shape. In particular in such embodiments, it can be useful to form the seal 108, which cannot be seen here, and the stack longitudinal axis stabilizer 116 as a one-piece seal/stabilizer unit 180. Such a seal/stabilizer unit 180 is shown in section, for example, in FIGS. 36, 38, 39, and 40. The seal/stabilizer units 180 shown there have a support region 178 connected to the seal 108 via the fixing region 170. As FIG. 35 shows, the abutments 118 can each comprise a part of the stack enclosure 174 and counter-elements 172 arranged thereon, which press against the support regions 178 with a defined prestressing force.

Counter-elements 172 can be arranged so as to be slidable on the stack enclosure 174 in order to be able to set the defined prestressing force on the support regions of the stack longitudinal axis stabilizers 116 or seal/stabilizer units 180.

In fuel cell stacks 100 of FIG. 32-35, counter-bearing contact surfaces 123 are each surfaces, facing the support region 178, of the counter-elements 172. Sliding contact surfaces 121 are each surfaces, facing the abutment contact surfaces 123, of the support regions 178.

The sections of FIG. 36-40 show edge regions of bipolar plates 104 with membrane electrode unit 106 and seal 108 arranged between the bipolar plates 104, with a fixing region 170 which extends into a plate intermediate space 176, and with a support region 178. The bipolar plates 104 each define on their edge a seal receiving region 190 and a stabilizer receiving region 192. The stabilizer receiving region 192 lies between the edge of the bipolar plates 106 and the seal receiving region 190.

In the embodiment of FIG. 37, the fixing region 170 and the support region 178 are part of a stack longitudinal axis stabilizer 116 which is detached from the seal 108. In the embodiments of FIGS. 36, 38, 39, and 40, both the two regions 170 and 178 that are characteristic of the stack longitudinal axis stabilizer 116, and the seal 108 are part of a one-piece seal/stabilizer unit 180.

It is clear from FIGS. 32 and 35 that support regions typically extend only over portions of the edges of bipolar plates 104, and not over the entire length of the edges around bipolar plates. In the seal/stabilizer unit 180 of FIGS. 36, 38, 39, and 40, the longest extent of the seal 108 is greater than the longest extent of the support region 178.

In FIG. 36-40, the support region is embodied to be thicker in the direction of the stack longitudinal axis than the fixing region. The support region has two shoulders in each case. The shoulders extend over the edge surfaces of the two bipolar plates, between which the fixing region is affixed.

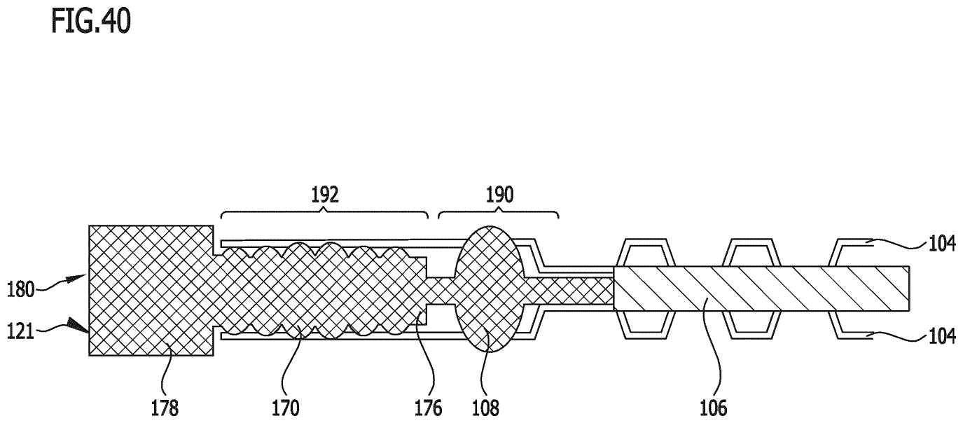

FIGS. 38 and 39 show embodiments with bipolar plates 104 made of metal, with an optional adaptation of the edge of the bipolar plates 104. The adaptation of the edge is aimed at avoiding damage to the stack longitudinal axis stabilizer or the seal/stabilizer unit 180 under vibration load. By bending (FIG. 38) or flanging (FIG. 39), the cutting effect of the metal edge on the support region 178 or its shoulder can be reduced to a permissible degree. In both embodiments of FIGS. 38 and 39, an edge support surface 194 is thus defined on an edge surface, oriented orthogonally to the plate plane, of the bipolar plate, the width D of which support surface, measured orthogonally to the plate plane, exceeds the bipolar plate material thickness.

FIG. 36-40 show the seal 108, the fixing region 170, and the membrane electrode unit 106, each in their uncompressed thickness. In the fuel cell stack, seal 108 is pressed onto a sealing gap, and likewise the fixing region 170 and the membrane electrode unit 106 corresponding to the applied bracing force. The deformation under the pressing arising from the acting bracing force is not shown in FIG. 36-40.

In FIG. 36-40, parts of the fixing region 170 are thickened in each case. In the fixing region of FIG. 37, four thickenings are formed on one side. In fixing regions of FIGS. 36, 38, and 39, three thickenings are formed on both sides.

The sliding contact surface 121 is in each case a surface of the support element 178.

FIG. 40 shows an embodiment in which the fixing region 170 is embodied such that the force required to press the fixing region 170 between the bipolar plates 104 decreases towards edges of the fixing region 170. The thickness of the fixing region 170 is in each case smaller at a thickening next to the support element 178 and at a thickening furthest away from the support element than the thickness of a thickening formed between these two thickenings.

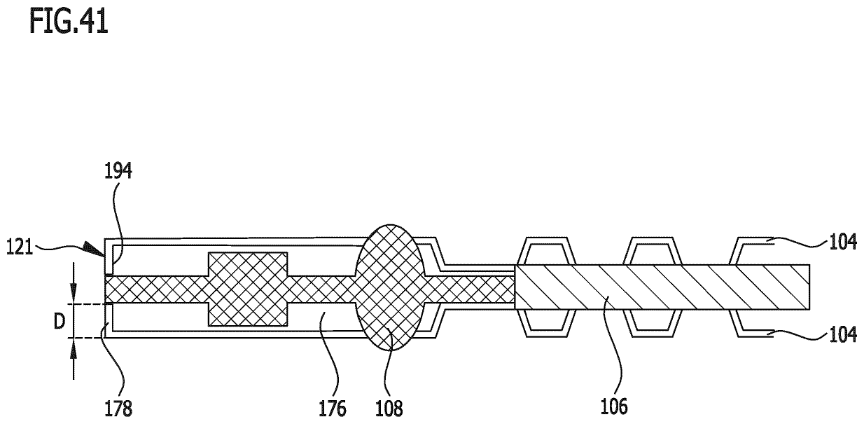

The section of FIG. 41 also shows an edge region of bipolar plates 104 with membrane electrode unit 106 and seal 108 arranged between the bipolar plates 104. In the embodiment shown here, an edge surface of the bipolar plate defines an edge support surface 194, the width D of which, measured orthogonally to the plate plane, exceeds the bipolar plate material thickness. The stack longitudinal axis of the fuel cell stack can then be stabilized by arranging this edge support surface 194 on an abutment—for example, on the stack enclosure.

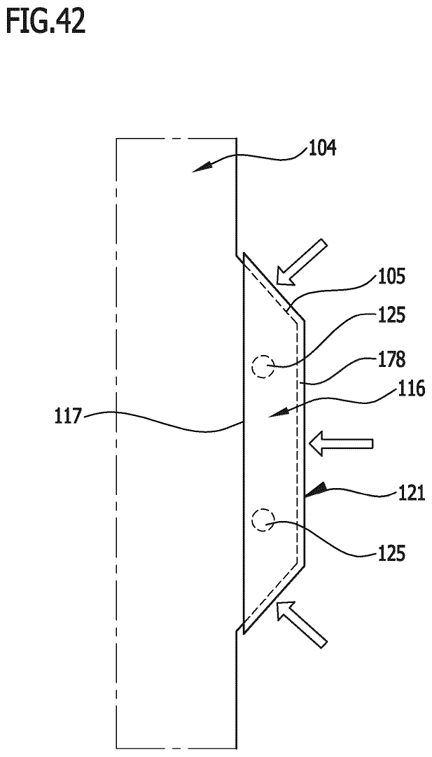

A further possibility for stabilizing a fuel cell stack along the stack longitudinal axis is shown in FIG. 42. An edge region of a bipolar plate 104 according to the invention is shown there. A plate projection region 105 in the form of a tab extends into a recess 117 of the stack longitudinal axis stabilizer 116. The recess 117 is a slot.

The recess 117 is delimited by a recess edge region. This is adapted continuously to the edge contour of the tab shown in dotted lines. The recess edge region thus delimits the depth and length of the recess 117.

The support element 178 of the stack longitudinal axis stabilizer 116 is formed by a region of the stack longitudinal axis stabilizer 116 which protrudes beyond the tab in the plane of the bipolar plate. The recess edge region thus lies in the transition from the recess 117 to the support element 178.

The sliding contact surface 121 comprised by the stack longitudinal axis stabilizer is a surface of the support element 178, viz., the surface, located opposite to the recess edge region on the support element 178, of the support element 178.

The sliding contact surface 121 can, for example, rest against an inner surface (not shown in FIG. 42) of a stack enclosure. The inner surface, functioning as an abutment contact surface, of the stack enclosure then defines, together with the sliding contact surface 121, the sliding contact region running parallel to the stack longitudinal axis.

In the example shown here, the tab is arranged in the recess 117 in a force-locking and positive-locking manner. The stack longitudinal axis stabilizer 116 is here a plastic part which is formed by overmolding the tab of the bipolar plate 104 with a plastic.

The stack longitudinal axis stabilizer 116 is connected to the tab by an undercut. The tab has two tab indentations 125. The tab indentations 125 can be openings which, in the region of the tab, pass through the bipolar plate 104. The plastic of the stack longitudinal axis stabilizer 116 formed by overmolding the tab extends into the tab indentations 125. The stack longitudinal axis stabilizer 116 thus engages in the tab indentations 125.

### LIST OF REFERENCE SIGNS

Fuel cell stack 100
Fuel cell stack portion 102
Bipolar plate 104
Plate projection region 105
Membrane electrode unit 106
Seal 108
Intermediate plate 110
Connecting element 111
Anode region 112
Cathode region 114
Stack longitudinal axis stabilizer 116
Recess 117
Abutment 118
Adjustable abutment element 119
Sliding support element 120
Sliding contact surface 121
Carrier 122
Abutment surface 123
Guide element 124
Tab indentation 125
Floating bearing element 126
Spring 128
Buffer element 130
Rail element 132
Further element 134
Stack contour 136
Tension anchor element 138
Support cushion element 140
Tension anchor plate 142
Pressure distributor plate 144
Force introduction plate 146
Bulk material 150
Molded part 160
Fixing region 170
Counter-element 172
Stack enclosure 174
Plate intermediate space 176
Support region 178
Seal/stabilizer unit 180
Seal receiving region 190
Stabilizer receiving region 192
Edge support surface 194
Cell 200
Cell suspension element 202
Head region 204
Neck region 206
Collar region 208
Abutment surface 210
Suspension surface 212
Abutment surface 214
Suspension surface 216
Suspension counter-element 218
Cell frame element 220
Cell suspension frame element 222
Damping element 230
Counter bearing 240
Channel portion 250
Sensor element 260
Tension anchor stabilizer 270
Tension anchor attachment element 272
Attachment securing element 274
Stabilizer strut region 276
Stabilizer strut region 278
Stabilizer strut region 280
Stabilizer strut region 282
Latching head 284
Intermediate plate attachment element 286
Fuel cell device 300

1. Fuel cell device, wherein the fuel cell device comprises the following:
a fuel cell stack, and
a stack longitudinal axis stabilizer,
wherein at least one region of the stack longitudinal axis stabilizer is arranged between a stack surface of the fuel cell stack extending in parallel with the stack longitudinal axis and an abutment.

2. Fuel cell device according to claim 1, wherein successive reaction zones along the stack longitudinal axis are each sealed by seals.

3. Fuel cell device according to claim 1, wherein the stack longitudinal axis stabilizer is capable of transmitting at least part of a force, which acts on the fuel cell stack orthogonally to the stack longitudinal axis, to the abutment.

4. Fuel cell device according to claim 1, wherein at least part of the stack longitudinal axis stabilizer is elastic.

5. Fuel cell device according to claim 1, wherein the stack longitudinal axis stabilizer comprises a sliding contact surface and the abutment comprises an abutment contact surface, the sliding contact surface being arranged on the abutment contact surface and the abutment contact surface, together with the sliding contact surface, defining a sliding contact region extending in parallel with the stack longitudinal axis.

6. Fuel cell device according to claim 1, wherein the shape and material of the stack longitudinal axis stabilizer are adapted to the structure of the fuel cell stack and the stack surface in such a way that acceleration a of 5 g orthogonally to the stack longitudinal axis does not lead to damage to the fuel cell stack.

7. Fuel cell device according to claim 1, wherein the stack longitudinal axis stabilizer comprises an intermediate plate inserted into the fuel cell stack.

8. Fuel cell device according to claim 1, wherein the stack longitudinal axis stabilizer comprises a support element which supports the stack surface against the abutment.

9. Fuel cell device according to claim 1, wherein the abutment is formed by a rail element extending along a stack surface of the fuel cell stack.

10. Fuel cell device according to claim 1, wherein
the stack longitudinal axis stabilizer comprises a support pad element;
the stack longitudinal axis stabilizer comprises a bulk material; and/or
the stack longitudinal axis stabilizer comprises a shaped part.

11. Fuel cell device according to claim 1, wherein a fixing region of the stack longitudinal axis stabilizer extends into a plate gap.

12. Fuel cell device according to claim 11, wherein the fixing region is clamped in the plate gap by the two adjacent bipolar plates.

13. Fuel cell device according to claim 12, wherein the average pressure exerted on the fixing region in the plate gap by the two adjacent bipolar plates is higher than the average pressure exerted on the seal(s) in the plate gap by the two adjacent bipolar plates.

14. Fuel cell device according to claim 1, wherein at least one seal and the stack longitudinal axis stabilizer are formed as a one-piece seal-stabilizer unit.

15. Fuel cell device according to claim 1, wherein a convex region of a bipolar plate, e.g. a plate protrusion region, extends into a recess of the stack longitudinal axis stabilizer.

16. Seal-stabilizer unit for sealing successive reaction zones along the stack longitudinal axis of a fuel cell stack, having a seal, a fixing region and a support region which is connected to the seal via the fixing region.

17. Bipolar plate for a fuel cell stack, wherein an edge surface of the bipolar plate defines an edge support surface, the width D of which, measured orthogonally to the plate plane, exceeds the bipolar plate material thickness.

18. Fuel cell device, wherein the fuel cell device comprises a fuel cell stack having at least one bipolar plate according to claim 17, wherein the stack longitudinal axis of the fuel cell stack is stabilized by the edge support surface being arranged on an abutment.

19. Bipolar plate for a fuel cell stack, wherein the bipolar plate comprises a convex region and a stack longitudinal axis stabilizer, wherein the convex region of the bipolar plate extends into a recess of the stack longitudinal axis stabilizer.
